(19) United States
(12) Patent Application Publication
(10) Pub. No.: US 2025/0284647 A1
(43) Pub. Date: Sep. 11, 2025

(54) TECHNIQUES TO MULTIPLY MEMORY ACCESS BANDWIDTH USING A PLURALITY OF LINKS

(71) Applicant: Intel Corporation, Santa Clara, CA (US)

(72) Inventors: Zhonghua SUN, Shanghai (CN); Cong ZHANG, Shanghai (CN); Di ZHANG, Shanghai (CN); Gang CHEN, Shanghai (CN); Zhuangzhi LI, Shanghai (CN)

(21) Appl. No.: 18/859,417

(22) PCT Filed: May 23, 2022
(86) PCT No.: PCT/CN22/94445

§ 371 Date: Oct. 23, 2024

(51) Int. Cl. G06F 13/16; G06F 12/02

(52) U.S. Cl. CPC G06F 13/1615; G06F 12/0284; G06F 13/1678

(57) ABSTRACT

Examples include techniques to multiply memory access bandwidth using a plurality of links. Example techniques may include generation and use of forwarding tables separately maintained at devices coupled via high speed internal-connect links (HSILs). A forwarding table to enable a first device to route a memory request received by the first device to access a memory address of a memory at a second device. The memory request received by the first device from a host compute device via a link between the first device and the host compute device, the memory request to be forwarded to the second device via an HSIL coupled between the first and second devices.

### TECHNICAL FIELD

Examples described herein are related to access of a memory maintained at a device coupled to a processor.

### BACKGROUND

A rapid rise in artificial intelligence (AI) and high performance computing (HPC) usage has increased an importance of a role that types of accelerators such as graphic processing units (GPUs) serve in AI and HPC. GPUs, in particular, have gained a relatively high amount of attention as GPU performance has increased by more than a factor of 10× in the past decade. However, as GPU performance continues to increase, these higher performing GPUs are somewhat starved for data due to a relatively slower link that couples these higher performing GPUs to a central processing unit (CPU). For example, a link operated according to a specification or standards such as published by the PCI-SIG® to include the PCI Express Specification, Rev. 6.0, Ver. 1.0, published in January of 2022 (“the PCIe specification”).

Ongoing efforts are being made to accelerate or increase a bandwidth of links between a group of GPUs in a same system so that GPUs in the group may directly exchange data at a high speed. For example, NVIDIA® has developed a GPU-to GPU link known as NVLink™. NVLink may have a per GPU bandwidth of 500 gigabytes per second (GB/s) or more. Other GPU manufacturers such as Intel® Corporation are working on multi die fabrics that include links having bandwidths similar to that of NVLink. NVLinks included in multi die fabrics or other types of similar links included in multi die fabrics that interconnect GPUs and/or accelerators may be referred to as “high speed internal-connect links” (HSILs). In some examples, these types of HSILs that interconnect GPUs are designed to facilitate GPU-GPU or accelerator-accelerator communications.

### BRIEF DESCRIPTION OF THE DRAWINGS

FIG. 1 illustrates an example system.

FIG. 2 illustrates example memory forwarding tables.

FIG. 3 illustrates an example scheme.

FIG. 4 illustrates an example DVSEC range structure.

FIG. 5 illustrates an example DVSEC capabilities register.

FIG. 6 illustrates an example CXL early detection table (CEDT).

FIG. 7 illustrates an example CBHS table.

FIG. 8 illustrates an example CXL binding HDM structure (CBHS) table.

FIG. 9 illustrates an example first logic flow.

FIG. 10 illustrates an example second logic flow

FIG. 11 illustrates an example third logic flow.

FIG. 12 illustrates an example process.

FIG. 13 is a block diagram of an example processing system.

FIG. 14A is a block diagram of an example of a processor having one or more processor cores, an integrated memory controller, and an integrated graphics processor.

FIG. 14B is a block diagram of an example hardware logic of a graphics processor core block.

FIG. 14C illustrates an example graphics processing unit (GPU) that includes dedicated sets of graphics processing resources arranged into multi-core groups.

FIG. 14D is a block diagram of an example general-purpose graphics processing unit (GPGPU) that can be configured as a graphics processor and/or compute accelerator.

FIG. 15A is a block diagram of an example graphics processor, which may be a discrete graphics processing unit, or may be a graphics processor integrated with a plurality of processing cores, or other semiconductor devices such as, but not limited to, memory devices or network interfaces.

FIG. 15B illustrates an example graphics processor having a tiled architecture.

FIG. 15C illustrates an example compute accelerator.

FIG. 16 is a block diagram of an example graphics processing engine of a graphics processor.

FIG. 17A illustrates an example graphics core cluster.

FIG. 17B illustrates an example vector engine of a graphics core.

FIG. 17C illustrates an example matrix engine of a graphics core.

FIG. 18 illustrates an example tile of a multi-tile processor.

FIG. 19 is a block diagram illustrating graphics processor instruction formats according to some examples.

FIG. 20 is a block diagram of another example of a graphics processor.

FIG. 21A is a block diagram illustrating a graphics processor command format that may be used to program graphics processing pipelines.

FIG. 21B is a block diagram illustrating an example graphics processor command sequence.

FIG. 22 illustrates an example graphics software architecture for a data processing system.

FIG. 23A is a block diagram illustrating an example IP core development system that may be used to manufacture an integrated circuit to perform operations.

FIG. 23B illustrates a cross-section side view of an example integrated circuit package assembly 1170.

FIG. 23C illustrates an example package assembly that includes multiple units of hardware logic chiplets connected to a substrate.

FIG. 23D illustrates an example package assembly including interchangeable chiplets.

FIG. 24 is a block diagram illustrating an example system on a chip integrated circuit that may be fabricated using one or more IP cores.

FIG. 25A illustrates an example graphics processor of a system on a chip integrated circuit that may be fabricated using one or more IP cores.

FIG. 25B illustrates an additional example of a graphics processor of a system on a chip integrated circuit that may be fabricated using one or more IP cores.

### DETAILED DESCRIPTION

In some example computing systems of today, accelerators or GPUs are coupled with or connected to a CPU through PCIe links. A PCIe link operated according to the PCIe specification (e.g., Rev. 6.0) may have a bandwidth or throughput of approximately 128 GB/sec. Comparatively, HSILs that interconnect groups of GPUs or accelerators may have a data bandwidth or throughput of 500 GB/sec or more and thus may have a data bandwidth of least 5 times greater than these types of PCIe links. As a result of this at least 5 times difference in data bandwidth or throughput, a CPU-to-GPU link becomes a bottleneck for processing large amounts of data in a system that includes GPUs interconnected via fast HSILs but separately connected with a CPU via substantially slower PCIe links.

A new technical specification by the Compute Express Link (CXL) Consortium is the Compute Express Link Specification, Rev. 2.0, Ver. 1.0, published Oct. 26, 2020, hereinafter referred to as “the CXL specification”. The CXL specification introduced the on-lining and off-lining of memory at a device (e.g., a GPU device or an accelerator device) attached to a host computing device through separate links that are each configured to operate in accordance with the CXL specification and are hereafter referred to as “CXL links”. The memory at the device that is on-lined or off-lined according to the CXL specification is referred to as host-managed device memory (HDM). Typically, each GPU or accelerator of a system of GPU or accelerators are connected to a CPU via separate CXL links. Since CXL links also operate according to the PCIe specification, throughput or bandwidth of CXL links may be limited to the 128 GB/sec that is mentioned above for PCIe links. So, in examples where a system of GPUs have GPU-GPU HSIL interconnections with at least 5 times a bandwidth of 128 GB/sec, a CXL link between a CPU and a GPU of the system may be over busy (e.g., at maximum bandwidth) and other CXL links to other GPUs may be idle or underutilized. It is with respect to these challenges that the examples described herein are needed.

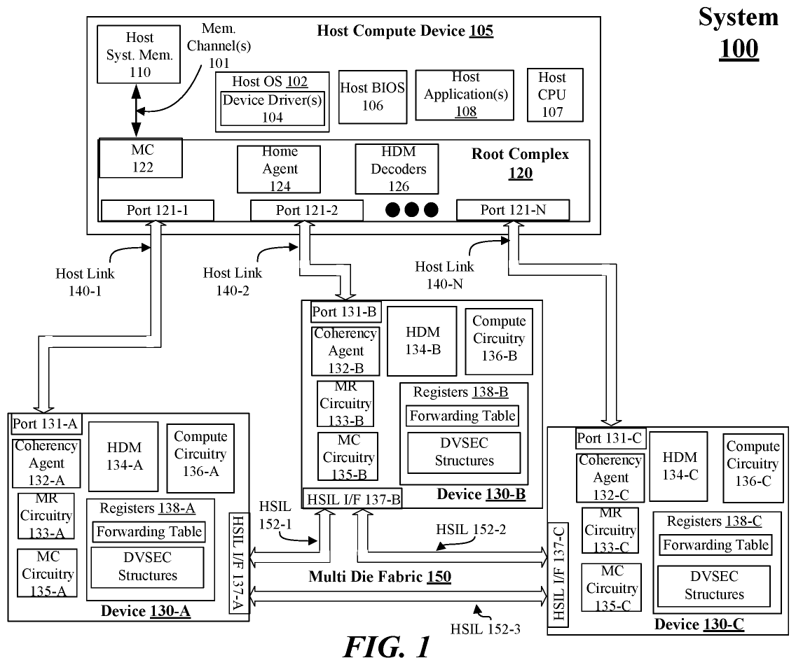

FIG. 1 illustrates an example system 100. In some examples, as shown in FIG. 1, system 100 includes host compute device 105 that has a root complex 120 to couple or connect with devices 130-A, 130-B and 130-C through respective ports 121-1, 121-2 and 121-N via respective host links 140-1, 140-2 and 140-3, where “N” is any positive, whole integer greater than 2. Host compute device 105, as shown in FIG. 1 also couples with a host system memory 110 via one or more memory channel(s) 101. For these examples, host compute device 105 includes a host operating system (OS) 102 to execute or support one or more device driver(s) 104, a host basic input/output system (BIOS) 106, one or more host application(s) 108 and a host central processing unit (CPU) 107 to support compute operations of host compute device 105.

In some examples, although shown in FIG. 1 as being separate from host CPU 107, root complex 120 may be integrated with host CPU 107 in other examples. For either example, root complex 120 may be arranged to function as a type of PCIe root complex for host CPU 107 and/or other elements of host compute device 105 to communicate with devices such as devices 130 via use of PCIe-based communication protocols and communication links. Root complex 120 may also be configured to operate in accordance with the CXL specification and as shown in FIG. 1, includes a home agent 124 to facilitate communications with devices 130 via host links 140. For these examples, host links 140 may be configured to operate according to the CXL specification. As shown in FIG. 1, root complex 120 includes HDM decoders 126 that may be programmed to facilitate a mapping of host to device physical addresses for use in accessing memory at or attached to devices 130. A memory controller (MC) 122 at root complex 120 may control/manage access to host system memory 110 through memory channel(s) 101. Host system memory 110 may include volatile and/or non-volatile types of memory. In some examples, host system memory 110 may include one or more dual in-line memory modules (DIMMs) that may include any combination of volatile or non-volatile memory. For these examples, memory channel(s) 101 and host system memory 110 may operate in compliance with a number of memory technologies described in various standards or specifications, such as DDR3 (DDR version 3), originally released by JEDEC (Joint Electronic Device Engineering Council) on Jun. 27, 2007, DDR4 (DDR version 4), originally published in September 2012, DDR5 (DDR version 5), originally published in July 2020, LPDDR3 (Low Power DDR version 3), JESD209-3B, originally published in August 2013, LPDDR4 (LPDDR version 4), JESD209-4, originally published by in August 2014, LPDDR5 (LPDDR version 5, JESD209-5A, originally published by in January 2020), WIO2 (Wide Input/output version 2), JESD229-2 originally published in August 2014, HBM (High Bandwidth Memory), JESD235, originally published in October 2013, HBM2 (HBM version 2), JESD235C, originally published in January 2020, or HBM3 (HBM version 3), JESD238, originally published in January 2022, or others or combinations of memory technologies, and technologies based on derivatives or extensions of such specifications. The JEDEC standards or specifications are available at www.jedec.org.

According to some examples, as shown in FIG. 1, devices 130-A, 130-B and 130-C may be interconnected via respective HSILs 152-1, 152-2 and 152-3 included in a multi die fabric 150. For these examples, each link included in HSILs 152 may be capable of having a data bandwidth or throughput (e.g., >500 GB/sec) that is substantially higher than a data bandwidth or throughput of each link included host links 140 (e.g., around 100 GB/sec). As described in more detail below, when elements of system 100 are operated according to the CXL specification, a coherent memory accessing capability is possible between devices 130-A, 130-B and 130-C and host compute device 105 via respective host links 140-1, 140-2 and 140-3. The coherent memory accessing capability makes it possible to increase data bandwidth between host compute device 105 and a device from among devices 130 by leveraging adjacent host links to transfer data via host links 140 in parallel so the data bandwidth could be multiplexed or multiplied for access to memory at devices 130.

In some examples, as shown in FIG. 1, devices 130 each include a port 131, a coherency agent 132 (e.g., a CXL device coherency agent (DCOH)), memory router (MR) circuitry 133, host-managed device memory (HDM) 134, memory controller circuitry 135, compute circuitry 136, an HSIL interface (I/F) 137 or registers 138. As described more below, circuitry or logic at devices 130 such as coherency agent 132 may separately receive a CXL.mem address from host compute device 105 via host links 140 and then utilize separately maintained forwarding tables included in registers 138 to enable MC circuitry 135 to access memory addresses for a targeted HDM 134 of a device from among devices 130. The accessed memory addresses may enable devices that don't include the targeted HDM memory to read or write data to the targeted HDM memory via a path that is routed via a first link included in host links 140 and a second link included in HSILs 152. Meanwhile the device including the targeted HDM memory may access the memory addresses via a path that is routed through a single link of host links 140. Since HSILs 152 have substantially higher bandwidths than host links 140, adding these HSIL links to access memory addresses in a targeted device HDM memory at another device memory may add relatively little latency. As a result, this method or scheme of parallel access using memory forwarding tables may nearly triple the available data bandwidth between host compute device 105 and the targeted device.

According to some examples, registers 138 included in devices 130 may be configured (e.g., programmed) to maintain a forwarding table and PCIe designated vendor-specific capability (DVSEC) structures. As mentioned briefly above and described more below, a device may use a forwarding table to determine where to access HDM memory addresses located at a targeted HDM memory. Also, as described more below, the forwarding tables maintained in registers 138 may be set or programmed based, at least in part on, information included in various DVSEC structures also maintained in registers 138. The various DVSEC structures, for example, may be set or programmed by a manufacture or vendor of devices 130 and then used by a BIOS (e.g., host BIOS 106) to set or program at least a portion of registers 138 to include a forwarding table.

According to some examples, HDM 134 may include volatile and/or non-volatile types of memory for use by compute circuitry 136 to execute, for example, a workload. The volatile and/or volatile types of memory may be resident on a same die or package as device 130 (e.g., stacked HBM die or stacked DRAM die) or may be an attached memory device (e.g., a DIMM). In some examples, compute circuitry 136 may be a GPU and the workload may be a graphics processing related workload or may be related to an AI workload that utilizes GPU processing capabilities offloaded to compute circuitry 136 by host CPU 107. In other examples, compute circuitry 136, may be at least part of an FPGA, ASIC or CPU serving as an accelerator and the workload may be offloaded from host compute device 105 for execution by these types of compute circuitry that include an FPGA, ASIC or CPU. Also, coherency agent 132, MR circuitry 133, or MC circuitry 135 may be at least part of the FPGA, ASIC or CPU that is used for offloading the workload from host compute device 105.

As mentioned above, host system memory 110 and HDM 134 may include volatile or non-volatile types of memory. Volatile types of memory may include, but are not limited to, random-access memory (RAM), Dynamic RAM (DRAM), DDR synchronous dynamic RAM (DDR SDRAM), GDDR, HBM, static random-access memory (SRAM), thyristor RAM (T-RAM) or zero-capacitor RAM (Z-RAM). Non-volatile memory may include byte or block addressable types of non-volatile memory having a 3-dimensional (3-D) cross-point memory structure that includes, but is not limited to, chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), anti-ferroelectric memory, resistive memory including a metal oxide base, an oxygen vacancy base and a conductive bridge random access memory (CB-RAM), a spintronic magnetic junction memory, a magnetic tunneling junction (MTJ) memory, a domain wall (DW) and spin orbit transfer (SOT) memory, a thyristor based memory, a magnetoresistive random access memory (MRAM) that incorporates memristor technology, spin transfer torque MRAM (STT-MRAM), or a combination of any of the above.

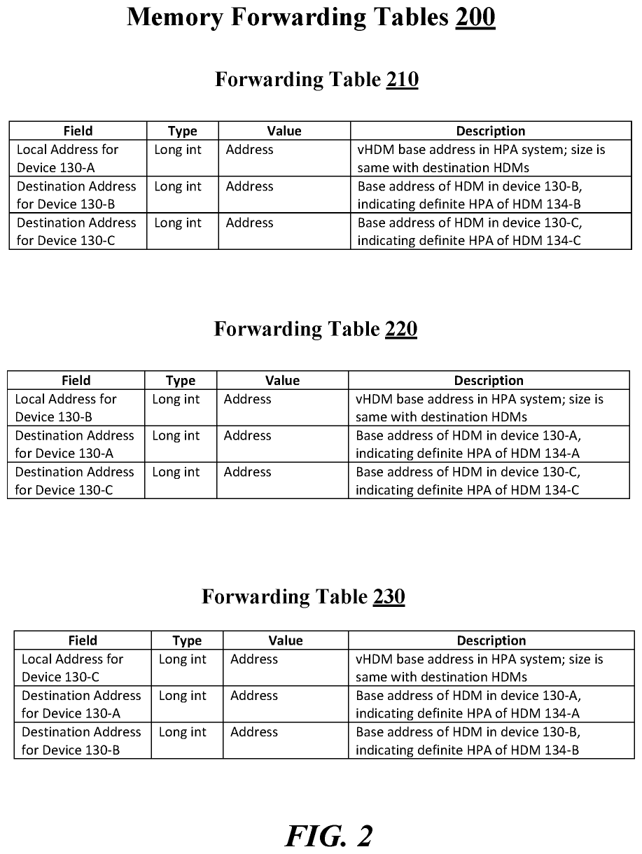

FIG. 2 illustrates example forwarding tables 200. In some examples, as shown in FIG. 2, forwarding tables 200 includes a forwarding table 210, a forwarding table 220 and a forwarding table 230. For these examples, forwarding table 210 may be maintained in registers 138-A at device 130-A, forwarding table 220 may be maintained in registers 138-B at device 130-B and forwarding table 230 may be maintained in registers 138-C at device 130-C.

As described more below, upon initialization of device 130-A, a BIOS (e.g., host BIOS 106) may program at least a portion of registers 138-A to set a first value indicating a local address that serves as a virtual HDM (vHDM) base address for memory addresses of HDM 134-A that can be mapped to a host physical address (HPA) system (e.g., maintained by host compute device 105). The BIOS may also set respective second and third values indicating respective destination addresses for devices 130-B and 130-C. In some examples, the respective destination addresses may serve as base addresses of HDM 134-B and HDM 134-C that can also be mapped to the HPA system and indicate definite, respective HPAs of HDM 134-B and HDM 134-C. Also, a size or memory capacity associated with each base address that is indicated for the local address may be a same size associated with respective destination addresses for HDM 134-B and HDM 134-C. A similar process may occur upon initialization of devices 130-B and 130-C to program respective at least portions of registers 138-B and 138-C to build vHDM and HDM maps as shown in FIG. 2 for forwarding tables 220 and 230.

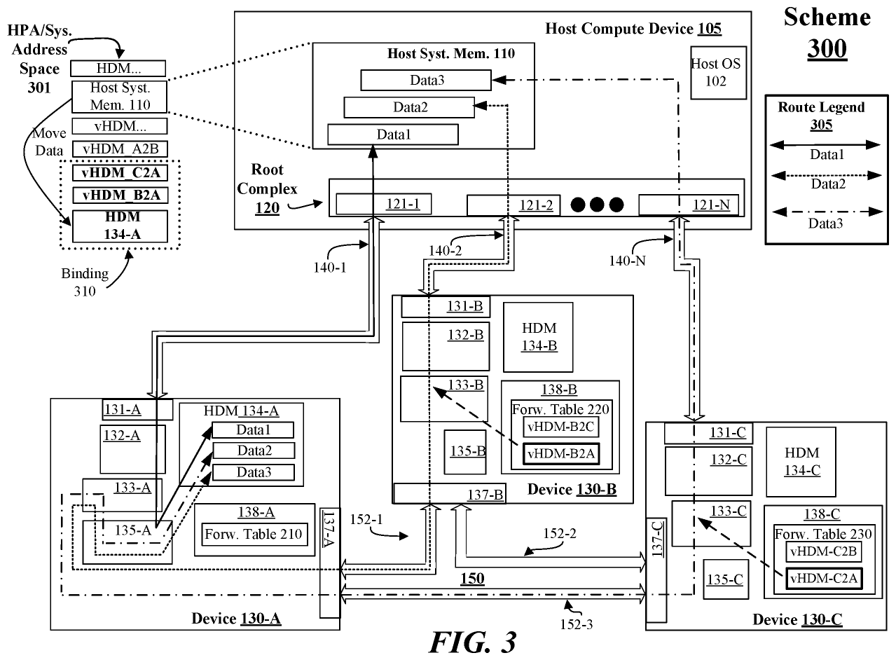

FIG. 3 illustrates an example scheme 300. According to some examples, scheme 300 shows an example of how data may be routed through host links separately connected between a host compute device and different devices in order to read or write data to an HDM of a device from among the different devices using forwarding tables programmed to registers of each device. For these examples, compute device 105 and devices 130-A, 130-B and 130-C may be configured to operate host links 140-1 to 140-N according to the CXL specification and may use CXL.mem protocols to route data via these host links. As shown in FIG. 3, elements of host compute device 105 such as host OS 102, host system memory 110, root complex 120 and ports 121-1 to 121-N are describe below as taking part in scheme 300. Also, elements of devices 130-A, 130-B or 130-C that are interconnected via HSILs 152-1 to 152-3 of multi die fabric 150 are described below as taking part in scheme 300. Scheme 300 is not limited to these elements of devices 130-A, 130-B, 130-B or compute device 105 as taking part in scheme 300.

According to some examples, HPA/system address space 301 as shown in FIG. 3 may be an example of how a host-managed device memory (HDM) 134-A may be mapped to host system memory 110. As described more below, binding 310 of HPA/system address space 301 may be based on forwarding tables programmed to registers 138-A, 138-B and 138-C (e.g., by host BIOS 106) that bind virtual HDMs (vHDMs) of device 130-B and 130-C to device 130-A's HDM 134-A. For example, as shown in FIG. 3, vHDM_B2A included in forwarding table 220 of device 130-B and vHDM_C2A included in forwarding table 230 of device 130-B may be bound to HDM 134-A according to binding 310. Each bound address may be a same size or represent a memory address or range of memory addresses to access a same amount of memory capacity.

In some examples, logic and/or features of host OS 102 may decide to split data associated with an access to memory addresses for HDM 134-A. For these examples, the splitting of the data includes a decision to multiplex host links 140-1 to 140-N in order to increase a data bandwidth to access HDM 134-A that also utilizes the higher bandwidth capabilities of HSILs 152-1 to 152-3 of multi die fabric 150 to facilitate that access of HDM 134-A. Data1, Data2, Data3 shown in FIG. 3 represent the splitting of data to be multiplexed over host links 140-1 to 140-N. Route legend 305 indicates that data1 having a solid, black line is routed through port 121-1 and host link 140-1 to device 130-A, data2 having a dotted, black line is routed through port 121-2 and host link 140-2 to device 130-B and data3 having a dash/dot, black line is routed through port 121-N and host link 140-3.

According to some examples, as described more below, host OS 102 may utilize CXL.mem request messages sent via host links 140-1 to 140-N to access HDM 134-A via multiple routes through these host links. Each device from among devices 130-A, 130-B and 130-C may receive separate CXL.mem request messages to indicate which portion of HDM 134-A is to be accessed. For these examples, circuitry of device 130-A such as MR circuitry 133-A may receive a CXL.mem request message indicating data1 is associated with memory addresses of HDM 134-A to access. Since HDM 134-A is local to device 130-A, MC circuitry 135-A accesses HDM 134-A to complete the access to memory addresses associated with data1. Device 130-A may then send a response message back to host OS 102 via host link 140-1. Circuitry of device 130-B such as MR circuitry 133-B may receive a CXL.mem request message indicating data2 is associated with memory addresses of HDM 134-A to access. Since HDM 134-A is not local to device 130-B, MR circuitry 133-B may refer to forwarding table 220 to determine that vHDM_B2A indicates to route a memory request for data2 via HSIL 152-1 to device 130-A. Circuitry of device 130-C such as MR circuitry 133-C may receive a CXL.mem request message indicating data3 is associated with memory addresses of HDM 134-A to access. Since HDM 134-A is not local to device 130-C, MR circuitry 133-C may refer to forwarding table 220 to determine that vHDM_C2A indicates to route a memory request for data3 via HSIL 152-3 to device 130-A. MC 135-A, upon receipt of the separate memory requests for data2 and data3 may access HDM 134-A according to the memory addresses indicated in the separate memory requests and then send a response indicating a status of the memory access to HDM 134-A back to device 130-B via HSIL 152-1 and a response indicating a status of the memory access to HDM 134-A back to device 130-C via HSIL 152-3. Devices 130-B and 130-C may then send separate responses indicating respective statuses of the memory accesses to HDM 134-A back to host OS 102 via respective host links 140-2 and 140N. In some examples, if the CXL.mem request was to read data from HDM 134-A, respective responses sent by devices 130-A, 130-B and 130-C may include the data read from HDM 134-A. In other examples, if CXL.mem request was to write data to HDM 134-A, respective response sent by devices 130-A, 130-B and 130-C may indicate that the data was successfully written to HDM 134-A.

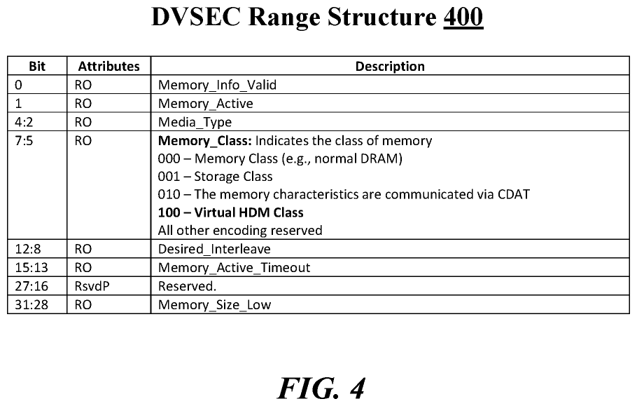

FIG. 4 illustrates an example DVSEC range structure 400. In some examples, DVSEC range structure 400 may be maintained in registers 138 of devices 130 of system 100 and may represent an example of a type of PCIe DVSEC structure that uses bits 7:5 of DVSEC range structure 400 to indicate a virtual HDM class. For these examples, as shown in FIG. 4, a bit pattern of 100 for bits 7:5 in DVSEC range structure 400 indicates a device supports vHDMs to enable the multiplexing of host links as mentioned above for scheme 300 and described more below. A vendor or manufacturer of device 130 may set the bit pattern in bits 7:5 to 100 to indicate support for use of vHDMs. DVSEC range structure 400 may be similar to a DVSEC CXL Range 2 Size Low structure described in the CXL specification but for the addition of a bit pattern of 100 in bits 7:5 to indicate support for a vHDM memory class.

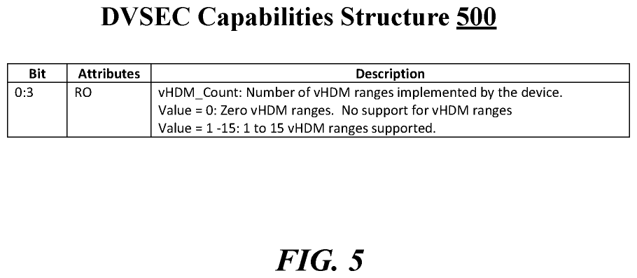

FIG. 5 illustrates an example DVSEC capabilities structure 500. According to some examples, DVSEC capabilities may be maintained in registers 138 of devices 130 of system 100 and may represent an example of a type of PCIe DVSEC structure that uses bits 0:3 of DVSEC capabilities structure 500 to indicate a number of vHDM ranges implemented by a device. For these examples, a value of 0 indicates no support for vHDM ranges and a value of 1-15 indicates support for 1 to 15 vHDM ranges. Examples are not limited to 15 vHDM ranges or to a DVSEC capabilities register having 4 bits to indicate a bit value of 0 to 15.

In some examples, a vendor or manufacturer of devices 130 may set the bit value of DVSEC capabilities structure 500 to indicate a number of vHDM ranges supported by devices 130. For example, devices 130-A, 130-B and 130-C may have DVSEC capabilities structures having a bit value of 2 to indicate support for 2 vHDM ranges. Support for 2 vHDM ranges indicates that a device 130 could route memory requests to up to 2 adjacent devices as mentioned above for scheme 300.

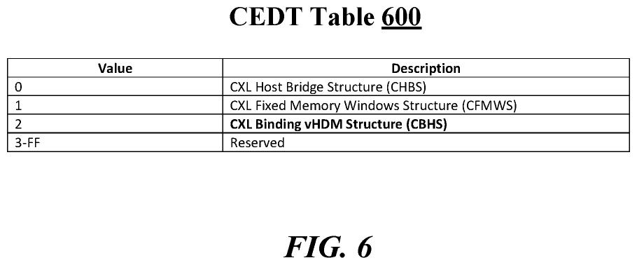

FIG. 6 illustrates an example CEDT 600. According to some examples, CEDT 600 may be linked to the Advanced Configuration and Power Interface, ver. 6.4, published in January 2021 by the United Extensible Firmware Interface (UEFI) Forum (hereinafter referred to as “the ACPI specification). A BIOS such as host BIOS 106 may expose device vHDM support information to an OS such as host OS 102 via an indication in CEDT 600 of a CXL binding HDM structure (CBHS) table. For example, a value 2 in CEDT 600 indicates that a CBHS has been built that includes device vHDM support information. For these examples, the BIOS may gather information from registers of devices to build the CBHS table and also build a binding vHDM structure table (both described more below) to expose the OS to vHDM support information gathered during initialization of devices in order to enable the OS to map HDM and vHDMs to an HPA/system address space such as HPA/system address space 301 shown in FIG. 3 and mentioned above.

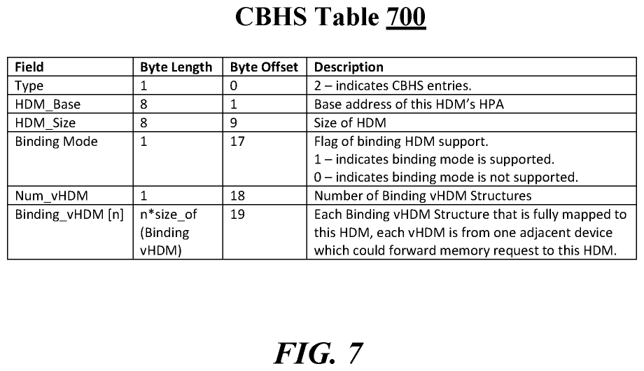

FIG. 7 illustrates an example CBHS table 700. CBHS table 700, as briefly mentioned above, may be built by a BIOS based on vHDM support information gathered during initialization of a device, e.g., gathered from DVSEC structures maintained in device registers such as registers 138. In some examples, as shown in FIG. 7, CBHS table 700 includes a type field and a value of 2 in the type filed indicates CBHS entries for an HDM are included in CHBHS table 700. An HDM_Base field indicates a base address of the HDM's HPA (e.g., a system memory HPA). An HDM_Size field indicates a size or memory capacity of an HDM. A Binding Mode field indicates whether a binding mode is support or not supported. A Num_vHDM field indicates a number of binding vHDM structures. A binding_vHDM[n] field indicates each binding vHDM structure that is fully mapped to the HDM, where each vHDM is from one adjacent device which could forward a memory request to the HDM. The “[n]” in the binding_vHDM[n] field may indicate that this field may contain up to “n” different entries, where “n” represents any positive integer greater than 0.

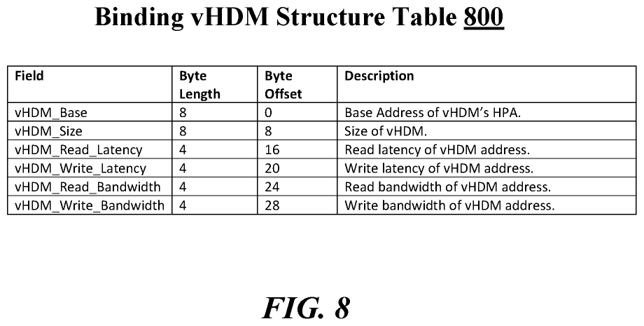

FIG. 8 illustrates an example binding vHDM structure table 800. Binding vHDM structure table 800 may be built by an OS (e.g., host OS 102) based on vHDM support information gathered during initialization of a device (e.g., gathered by a BIOS). In some examples, the information included in binding vHDM structure table 800 may be based on standard memory attributes provided by a vendor or manufacture of a device having host managed device memory and separate binding vHDM structure tables may be built by the OS for each vHDM that a device indicates as supporting. The OS, for example, may build the separate binding vHDM structure tables based on information included in a CBHS table such as example CBHS table 700 and based on information provided in an ACPI heterogeneous memory attribute table (HMAT). For these examples, as shown in FIG. 8, a vHDM_Base field indicates a base address of the vHDM's HPA (e.g., a system memory HPA). A vHDM_Size filed indicates a size or memory capacity of the vHDM. A vHDM_Read_Latency field indicates a read latency of the vHDM address. A vHDM_Write_Latency field indicates a write latency of the vHDM address. A vHDM_Read_Bandwidth field indicates a read bandwidth of the vHDM address. A vHDM_Write_Bandwidth field indicates a write bandwidth of the vHDM address.

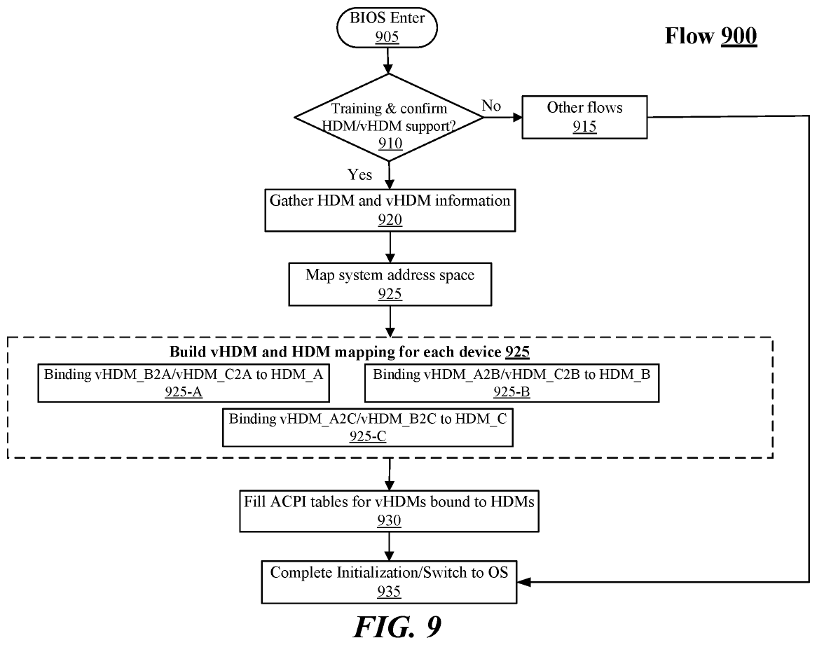

FIG. 9 illustrates an example logic flow 900. In some examples, logic flow 900 may be implemented by a BIOS for a host computing device coupled with multiple devices (e.g., GPU devices and/or accelerator devices having host-managed device memory). For these examples, host BIOS 106 of host compute device 105 coupled with devices 130 via host links 140 as shown in FIG. 1 or 3 for system 100 may implement at least portions of logic flow 900. The host computing device and devices connected via host links may be arranged to operate in accordance with the CXL specification. The devices may include registers having DVEC structures that include information gathered by the BIOS during initialization or startup of a system that includes the host computing device and the devices connected via separate host links. For example, information included in example DVSEC range structure 400 or example DVSEC capabilities structure 500 shown in FIGS. 4-5 that are maintained in registers 138 of devices 130 that may be gathered by host BIOS 106. Also, host BIOS 106 may cause forwarding tables such as forwarding tables 200 to be maintained in devices 130 as shown in FIG. 2 as part of implementing logic flow 900. Also, ACPI related tables such as CEDT table 600, CBHS table 700 or binding vHDM structure table 800 shown in FIGS. 6-7 may be filled by host BIOS 106 as part of implementing logic flow 900.

Logic flow 900 begins at block 905 where host BIOS 106 enters the flow. In some examples, host BIOS 106 enters logic flow 900 responsive to an initiation of system 100 and/or the initialization of at devices 130 included in system 100.

Moving from block 905 to decision block 910, host BIOS 106 completes any necessary training of host links 140 coupled between host compute device 105 and devices 130 to ensure the host links and devices can operate according to the CXL specification and confirms whether devices 130 indicate HDM/vHDM support. According to some examples, host BIOS 106 gathers information from a DVSEC range structure such as example DVSEC range structure 400 maintained in registers 138 of devices 130 to determine if a 100 bit pattern is set in bits 7:5 of the DVSEC range structure 400. If the 100 bit pattern is set in bits 7:5, vHDM support is indicated, logic flow 900 moves to block 920. Otherwise, logic flow 900 moves to block 915.

Moving from decision block 910 to block 915, host BIOS 106 completes other flows to finish its part of the initialization of system 100.

Moving from decision block 910 to block 920, host BIOS 106 gathers HDM and vHDM information from devices 130. According to some examples, BIOS 106 gathers the HDM and vHDM information from a DVSEC capabilities structure such as example DVSEC capabilities structures 500 maintained in registers 138 of devices 130.

Moving from block 920 to block 925, host BIOS 106 maps system address space. In some examples, the system address space that is mapped may be HPA/system address space 301.

Moving from block 925 to block 930, host BIOS 106 builds vHDM and HDM mapping for each device. According to some examples, as part of building a mapping for each device, sub-block 925-A is implemented to bind vHDM-B2A/vHDM-C2A to HDM_A to set various base addresses in HPA/system address space 301 in a similar manner as shown in forwarding table 210 of FIG. 2 and binding 310 shown in FIG. 3, sub-block 925-B is implemented to bind vHDM_A2B/vHDM_C2B to HDM_B to set various base addresses in a similar manner as shown in forwarding table 220 of FIG. 2, and sub-block 925-C is implemented to bind vHDM-A2C/vHDM_B2C to HDM_C to set various base addresses in a similar manner as shown in forwarding table 230 of FIG. 2. For these examples, host BIOS 106 may cause a portion of registers 138 of devices 130-A, 130-B and 130-C to be individually programmed to maintain respective forwarding tables 210, 220 and 230 based on the above mentioned bindings.

Moving from block 925 to block 930, host BIOS 106 fills ACPI tables for vHDMs bound to HDMs. In some examples, an example ACPI table to be filled may be a CEDT table such as CEDT table 600 shown in FIG. 6 that is filled by host BIOS 106 to indicate that host BIOS 106 has also filled a CBHS table such as CBHS table 700 shown in FIG. 7 for each HDM of a device.

Moving from block 915 or from block 930 to block 935, host BIOS 106 completes its portion of initialization of system 100 to allow subsequent operations to switch to an OS. According to some examples, an OS such as host OS 102 may implement subsequent operations.

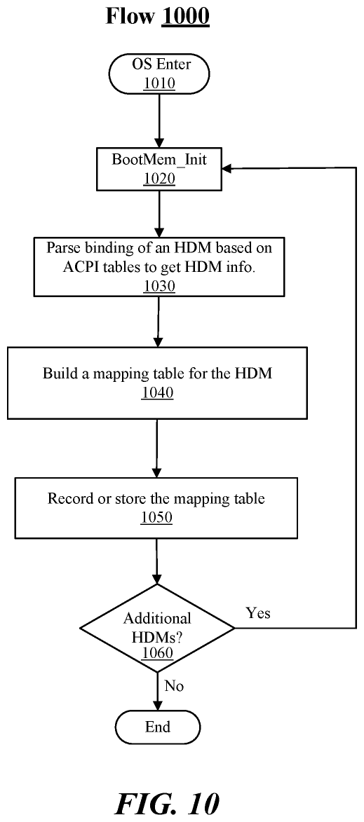

FIG. 10 illustrates an example logic flow 1000. In some examples, logic flow 1000 may be implemented by an OS for a host computing device such as host OS 102 for host compute device 105 as shown in FIG. 1 or 3. For these examples, host OS 102 may utilize various ACPI tables filled by a BIOS such as host BIOS 106 as mentioned above for logic flow 900 in order to initialize and bind HDM mapping tables in host OS 102 for subsequent use to multiplex host links 140-1 to 140-N in order to increase a data bandwidth to access an HDM at one of devices 130-A, 130-B or 130-C. Host OS 102 may implement logic flow 1000 for each HDM of devices 130-A, 130-B and 130-C.

Logic flow 1000 begins at block 1010 where host OS 102 enters logic flow 1000. According to some examples, OS 102 may enter logic flow 1000 upon start of an OS kernel (e.g., executed by host CPU 107).

Moving from block 1010 to block 1020, host OS 102 may cause a BootMem_Init to boot an HDM at a device coupled with host computing system 105 via a host link. For example host OS 102 may cause HBM 134-A at device 130-A coupled via host link 140-1 to boot.

Moving from block 1020 to block 1030, host OS 102 may parse a binding of an HDM of a device based on ACPI tables including information associated with the HBM to get HDM information for the HDM. In some examples, the ACPI tables includes a CBHS table such as CBHS table 700 that includes information to parse the binding of the HDM of the device. For example, a CBHS table for HBM 134-A at device 130-A may include information to parse a binding for HBM 134-A to vHDM-B2A/vHDM-C2A.

Moving from block 1030 to block 1040, host OS 102 builds a mapping table for the HBM. According to some examples, host OS 102 may build the mapping table by first filling HDM information for the HDM in a standard HPA table that may be maintained in host system memory 110. The standard HPA table, for example, may be for use by HDM decoders 126 and/or logic/features of host OS 102 to determine what HPAs are to be mapped to device physical addresses (DPAs) at the device that includes the HDM. Host OS 102 may then get binding address information for vHDMs bound to the HDM and fill the standard HPA table according to the binding address information. The binding address information for each vHDM may be based on information obtained from a binding vHDM structure table such as example binding vHDM structure table 800.

Moving from block 1040 to block 1050, host OS 102 may record or store the mapping table. According to some examples, as described more below, the mapping table may be stored to host system memory 110 for later use in determining how to route a data access to the HDM via multiple host links to increase a data bandwidth for the data access as compared to using a single host link to complete the data access to the HDM.

Moving from block 1040 to decision block 1060, host OS 102 determines whether any additional HDMs are to be booted and associated mapping tables to be built and stored. If more HDMs, logic flow 1000 moves to block 1020. If no more HDMs, logic flow 1000 comes to an end.

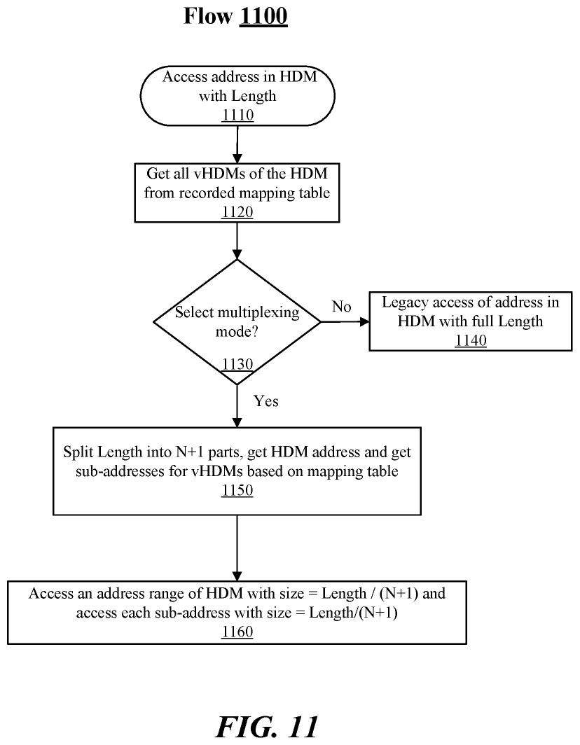

FIG. 11 illustrates an example logic flow 1100. In some examples, logic flow 1100 may be implemented by an OS for a host computing device such as host OS 102 for host compute device 105 as shown in FIG. 1 or 3. For these examples, host OS 102 may have completed the building of mapping tables for multiple HDMs of devices coupled to host compute device 105 as described above for logic flow 1000.

Logic flow 1100 begins at block 1110 where host OS 102 is to access an address in an HDM of a device with a Length. The access, for example, may be based on a data request from an application from among host application(s) 108 at host compute device 105 (e.g., associated with an AI or HPC workload). According to some examples, the Length may be associated with a data capacity (e.g., 1 GB) and a range of physical memory addresses in the HDM needed to store that data capacity. For these examples, the HDM to be accessed may be HDM 134-A of device 130.

Moving from block 1110 to block 1120, host OS 102 gets all vHDMs of the HDM to be accessed from the recorded mapping table. In some examples, the recorded mapping table may be stored to host system memory 110. The vHDMs, for example, may be vHDM-B2A at device 130-B and vHDM-C2A at device 130-C that have been bound to HDM 134-A.

Moving from block 1120 to decision block 1130, host OS 102 determines whether to select a multiplexing mode. According to some examples, the multiplexing mode may include routing access requests via host links 140-1 to 140-N and through devices 130-B and 130-C to increase a data bandwidth for accessing the address in HDM 134-A with a Length. For these examples, the determination may be based on meeting latency and/or data bandwidth requirements associated with system executing or supporting execution of a workload. The requirement may be based on, but not limited to, meeting a service level agreement or a quality of service policy. If a multiplexing mode is selected, logic flow 1100 moves to block 1150. If a multiplexing mode is not selected, logic flow 1100 moves to block 1140.

Moving from decision block 1130 to block 1140, host OS 102 uses a legacy access of the address in the HDM with full Length. In some examples, this would mean host OS 102 would access an address of HDM 134-A with full Length via only host link 141-1.

Moving from decision block 1130 to block 1150, host OS 102 splits Length into N+1 parts, gets an HDM address based on the mapping table, and gets N+1 Sub-addresses for vHDMs based on the mapping table. According to some examples, “N” may represent the number of vHDMs bound to the HDM. For example, N for HDM 134-A would be 2. An example equation to determine a sub-address for a vHDM may be Sub_Addr_m=Addr_in_HDM+N*(Length/N+1), where n=1, . . . ,N and m=0, . . . ,N−1.

Moving from block 1150 to block 1160, host OS 102 accesses an address range of HDM with size=Length/(N+1) and accesses each sub-address with size=Length/(N+1). In some examples, host OS 102 accesses HDM 134-A by sending a first CXL.mem request to device 130-A via host link 140-1, a second CXL.mem request to device 130-B via host link 140-2, and a third CXL.mem request to device 130-C via host link 140-N. The first CXL.mem request to include the determined HDM address for HDM 134-A and the second and third CXL.mem requests to include the determined sub-addresses for respective vHDMs B2A and C2A.

The set of logic flows shown in FIGS. 9-11 may be representative of example methodologies for performing novel aspects described in this disclosure. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

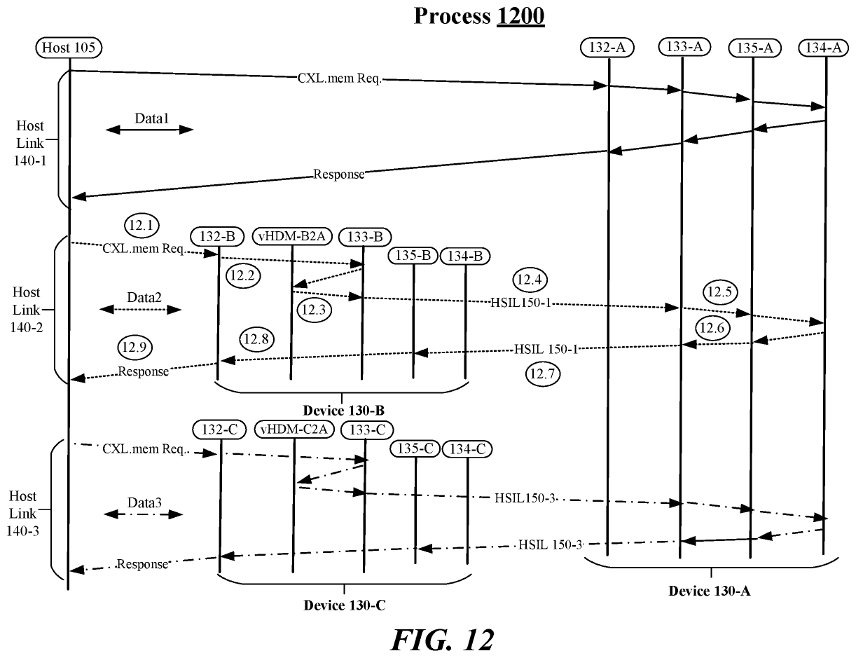

FIG. 12 illustrates an example process 1200. According to some examples, elements of system 100 shown in FIGS. 1 and 3 are used to describe process 1200. The elements of system 100 may include, but are not limited to, host 105, host links 140, devices 130 or HSILs 152. Also, elements of devices 130 are used to describe process 1200 that may include, but are not limited to, coherency agents 132, MR circuitry 133, MC circuitry 135 or HDMs 134. For these examples, process 1200 may be similar to scheme 300 described above and shown in FIG. 3 but with additional focus on actions taken by device 130-B upon receiving a CXL.mem request message from host 105 (e.g., from host OS 102) to access HDM 134-A based on a mapping table built and described above for logic flows 1000 and 1100 and using a forwarding table such forwarding table 220 described above for FIG. 2

Process 1200 begins at process 12.1 where host 105 sends a CXL.mem request message to device 130-B. According to some examples, host OS 102 of host 105 may have determined to multiplex multiple CXL.mem requests via host links 140-1 to 140-N to access an address in HDM 134-A. For these examples, the CXL.mem request includes a translated address (e.g., Addr_vHDM_1) in a range of addresses associated with vHDM-B2A that has been bound to HDM 134-A. Data2 indicates device 130-B is handling a CXL.mem request for a portion of a Length associated with the entire memory access.

At process 12.2, coherency agent 132 receives the CXL.mem request and forwards the translated address in the range of address associated with vHDM-B2A.

At process 12.3, MR circuitry 133-B uses forwarding table 220 maintained in registers 138-B to translate Addr_vHDM_1 to a sub-address of HDM 134-A.

At process 12.4, MR circuitry 133-B forwards a memory request for access to the translated sub-address of HDM 134-A associated with the CXL.mem request to device 130-A via HSIL 152-1.

At process 12.5, MR circuitry 133-A of device 130-A receives the memory request forwarded from device 130-B and confirms that the translated sub-address of HDM 134-A is for an address of HDM 134-A and forwards the memory request to MC circuitry 135-A for access to HDM 134-A at the translated sub-address.

At process 12.6, MR circuitry 133-A gets a response back from MC circuitry 135-A. In some examples, if the memory request is for writing data2 to HDM 134-A, the response is an indication of whether the data2 was successfully written to the translated sub-address of HDM 134-A. If the memory request is for reading data2 from HDM 134-A, the response may include data2 that was read from HDM 134-A.

At process 12.7, MR circuitry 133-A forwards the response from MC circuitry 135-A to MR circuitry 133-B at device 130-B via HSIL 152-1. MR circuitry 133-B may then translate the sub-address of HDM 134-A back to Addr_vHDM_1 indicated in the CXL.mem request received at device 130-B.

At process 12.8, MR circuitry 133-A then forwards the response for Addr_vHDM_1 for the CXL.mem request to coherency agent 132-B.

At process 12.9, coherency agent 132-B sends the response for the CXL.mem request to host 105 via host link 140-2.

According to some examples, separate CXL.mem requests including requests to access HDM 134-A for portions data1 and data3 may be sent to device 130-A and device 130-C in parallel with sending the CXL. mem request to access HDM 134-A for portion data2 as described above for process 12.1 to 12.9. Device 130-C will follow a similar process to access its requested data3 portion at HDM 134-A as was described for device 130-B. Device 130-A will directly access HDM 134-A and provide a response directly back to host 105 without the use of an HSIL.

### System Overview

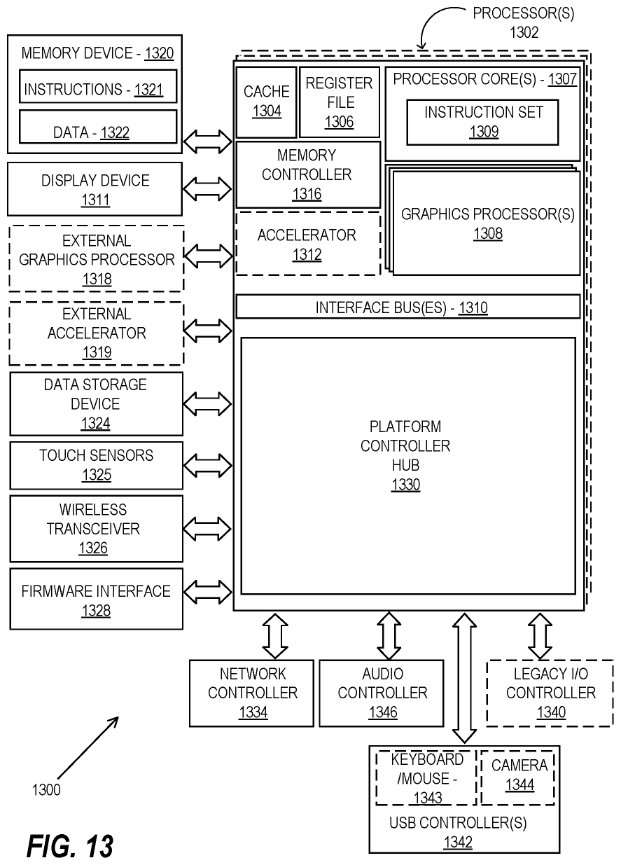

FIG. 13 is a block diagram of a processing system 1300, according to an embodiment. Processing system 1300 may be used in a single processor desktop system, a multiprocessor workstation system, or a server system having a large number of processors 1302 or processor cores 1307. In one embodiment, the processing system 1300 is a processing platform incorporated within a system-on-a-chip (SoC) integrated circuit for use in mobile, handheld, or embedded devices such as within Internet-of-things (IoT) devices with wired or wireless connectivity to a local or wide area network.

In one embodiment, processing system 1300 can include, couple with, or be integrated within: a server-based gaming platform; a game console, including a game and media console; a mobile gaming console, a handheld game console, or an online game console. In some embodiments the processing system 1300 is part of a mobile phone, smart phone, tablet computing device or mobile Internet-connected device such as a laptop with low internal storage capacity. Processing system 1300 can also include, couple with, or be integrated within: a wearable device, such as a smart watch wearable device; smart eyewear or clothing enhanced with augmented reality (AR) or virtual reality (VR) features to provide visual, audio or tactile outputs to supplement real world visual, audio or tactile experiences or otherwise provide text, audio, graphics, video, holographic images or video, or tactile feedback; other augmented reality (AR) device; or other virtual reality (VR) device. In some embodiments, the processing system 1300 includes or is part of a television or set top box device. In one embodiment, processing system 1300 can include, couple with, or be integrated within a self-driving vehicle such as a bus, tractor trailer, car, motor or electric power cycle, plane, or glider (or any combination thereof). The self-driving vehicle may use processing system 1300 to process the environment sensed around the vehicle.

In some embodiments, the one or more processors 1302 each include one or more processor cores 1307 to process instructions which, when executed, perform operations for system or user software. In some embodiments, at least one of the one or more processor cores 1307 is configured to process a specific instruction set 1309. In some embodiments, instruction set 1309 may facilitate Complex Instruction Set Computing (CISC), Reduced Instruction Set Computing (RISC), or computing via a Very Long Instruction Word (VLIW). One or more processor cores 1307 may process a different instruction set 1309, which may include instructions to facilitate the emulation of other instruction sets. Processor core 1307 may also include other processing devices, such as a Digital Signal Processor (DSP).

In some embodiments, the processor 1302 includes cache memory 1304. Depending on the architecture, the processor 1302 can have a single internal cache or multiple levels of internal cache. In some embodiments, the cache memory is shared among various components of the processor 1302. In some embodiments, the processor 1302 also uses an external cache (e.g., a Level-3 (L3) cache or Last Level Cache (LLC)) (not shown), which may be shared among processor cores 1307 using known cache coherency techniques. A register file 1306 can be additionally included in processor 1302 and may include different types of registers for storing different types of data (e.g., integer registers, floating point registers, status registers, and an instruction pointer register). Some registers may be general-purpose registers, while other registers may be specific to the design of the processor 1302.

In some embodiments, one or more processor(s) 1302 are coupled with one or more interface bus(es) 1310 to transmit communication signals such as address, data, or control signals between processor 1302 and other components in the processing system 1300. The interface bus 1310, in one embodiment, can be a processor bus, such as a version of the Direct Media Interface (DMI) bus. However, processor busses are not limited to the DMI bus, and may include one or more Peripheral Component Interconnect buses (e.g., PCI, PCI express), memory busses, or other types of interface busses. In one embodiment the processor(s) 1302 include a memory controller 1316 and a platform controller hub 1330. The memory controller 1316 facilitates communication between a memory device and other components of the processing system 1300, while the platform controller hub (PCH) 1330 provides connections to I/O devices via a local I/O bus.

The memory device 1320 can be a dynamic random-access memory (DRAM) device, a static random-access memory (SRAM) device, flash memory device, phase-change memory device, or some other memory device having suitable performance to serve as process memory. In one embodiment the memory device 1320 can operate as system memory for the processing system 1300, to store data 1322 and instructions 1321 for use when the one or more processors 1302 executes an application or process. The memory controller 1316 also couples with an optional external graphics processor 1318, which may communicate with the one or more graphics processors 1308 in processors 1302 to perform graphics and media operations. In some embodiments, graphics, media, and or compute operations may be assisted by an accelerator 1312 which is a coprocessor that can be configured to perform a specialized set of graphics, media, or compute operations. For example, in one embodiment the accelerator 1312 is a matrix multiplication accelerator used to optimize machine learning or compute operations. In one embodiment the accelerator 1312 is a ray-tracing accelerator that can be used to perform ray-tracing operations in concert with the graphics processor 1308. In one embodiment, an external accelerator 1319 may be used in place of or in concert with the accelerator 1312.

In some embodiments a display device 1311 can connect to the processor(s) 1302. The display device 1311 can be one or more of an internal display device, as in a mobile electronic device or a laptop device or an external display device attached via a display interface (e.g., DisplayPort, etc.). In one embodiment the display device 1311 can be a head mounted display (HMD) such as a stereoscopic display device for use in virtual reality (VR) applications or augmented reality (AR) applications.

In some embodiments the platform controller hub 1330 enables peripherals to connect to memory device 1320 and processor 1302 via a high-speed I/O bus. The I/O peripherals include, but are not limited to, an audio controller 1346, a network controller 1334, a firmware interface 1328, a wireless transceiver 1326, touch sensors 1325, a data storage device 1324 (e.g., non-volatile memory, volatile memory, hard disk drive, flash memory, NAND, 3D NAND, 3D XPoint, etc.). The data storage device 1324 can connect via a storage interface (e.g., SATA) or via a peripheral bus, such as a Peripheral Component Interconnect bus (e.g., PCI, PCI express). The touch sensors 1325 can include touch screen sensors, pressure sensors, or fingerprint sensors. The wireless transceiver 1326 can be a Wi-Fi transceiver, a Bluetooth transceiver, or a mobile network transceiver such as a 3G, 4G, 5G, or Long-Term Evolution (LTE) transceiver. The firmware interface 1328 enables communication with system firmware, and can be, for example, a unified extensible firmware interface (UEFI). The network controller 1334 can enable a network connection to a wired network. In some embodiments, a high-performance network controller (not shown) couples with the interface bus 1310. The audio controller 1346, in one embodiment, is a multi-channel high-definition audio controller. In one embodiment the processing system 1300 includes an optional legacy I/O controller 1340 for coupling legacy (e.g., Personal System 2 (PS/2)) devices to the system. The platform controller hub 1330 can also connect to one or more Universal Serial Bus (USB) controllers 1342 connect input devices, such as keyboard and mouse 1343 combinations, a camera 1344, or other USB input devices.

It will be appreciated that the processing system 1300 shown is exemplary and not limiting, as other types of data processing systems that are differently configured may also be used. For example, an instance of the memory controller 1316 and platform controller hub 1330 may be integrated into a discreet external graphics processor, such as the external graphics processor 1318. In one embodiment the platform controller hub 1330 and/or memory controller 1316 may be external to the one or more processor(s) 1302 and reside in a system chipset that is in communication with the processor(s) 1302.

For example, circuit boards (“sleds”) can be used on which components such as CPUs, memory, and other components are placed are designed for increased thermal performance. In some examples, processing components such as the processors are located on a top side of a sled while near memory, such as DIMMs, are located on a bottom side of the sled. As a result of the enhanced airflow provided by this design, the components may operate at higher frequencies and power levels than in typical systems, thereby increasing performance. Furthermore, the sleds are configured to blindly mate with power and data communication cables in a rack, thereby enhancing their ability to be quickly removed, upgraded, reinstalled, and/or replaced. Similarly, individual components located on the sleds, such as processors, accelerators, memory, and data storage drives, are configured to be easily upgraded due to their increased spacing from each other. In the illustrative embodiment, the components additionally include hardware attestation features to prove their authenticity.

A data center can utilize a single network architecture (“fabric”) that supports multiple other network architectures including Ethernet and Omni-Path. The sleds can be coupled to switches via optical fibers, which provide higher bandwidth and lower latency than typical twisted pair cabling (e.g., Category 5, Category 5e, Category 6, etc.). Due to the high bandwidth, low latency interconnections and network architecture, the data center may, in use, pool resources, such as memory, accelerators (e.g., GPUs, graphics accelerators, FPGAs, ASICS, neural network and/or artificial intelligence accelerators, etc.), and data storage drives that are physically disaggregated, and provide them to compute resources (e.g., processors) on an as needed basis, enabling the compute resources to access the pooled resources as if they were local.

A power supply or source can provide voltage and/or current to processing system 1300 or any component or system described herein. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

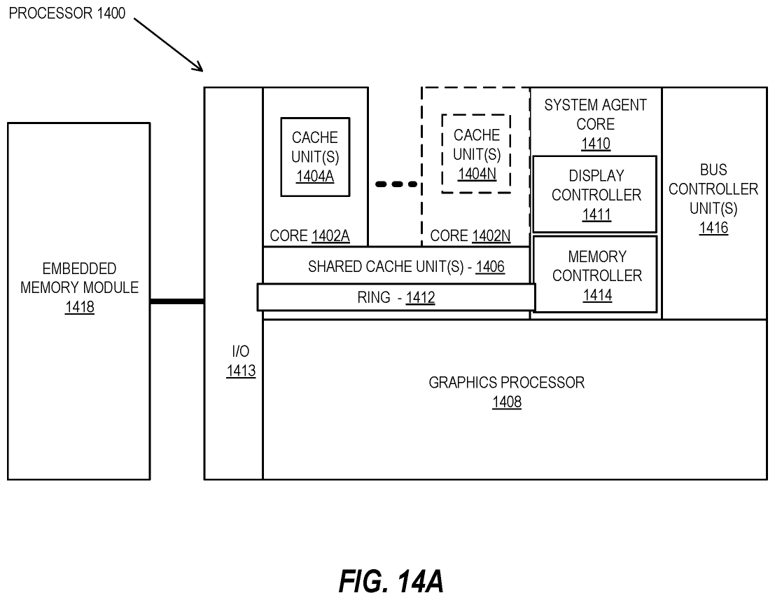

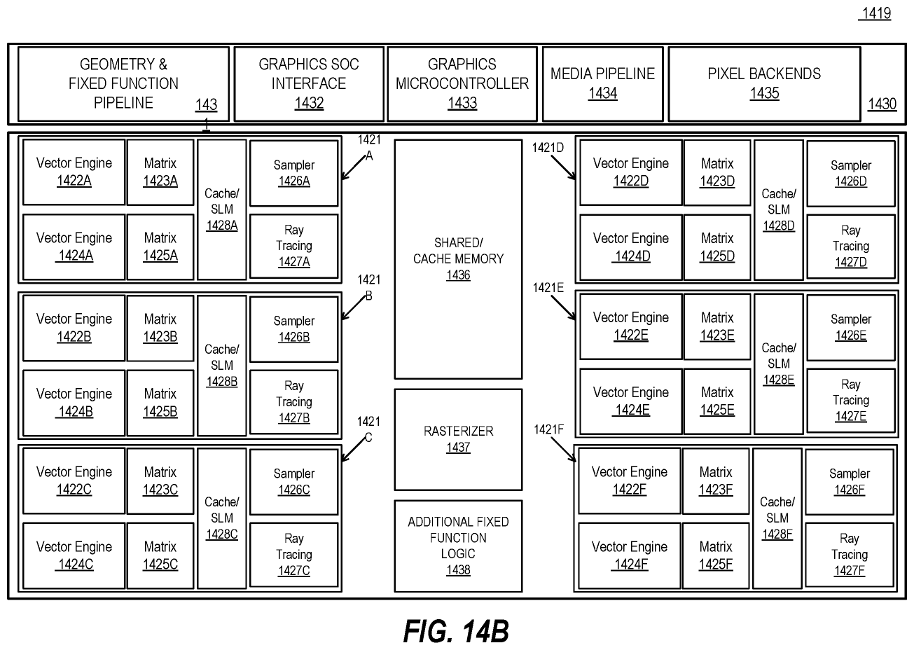

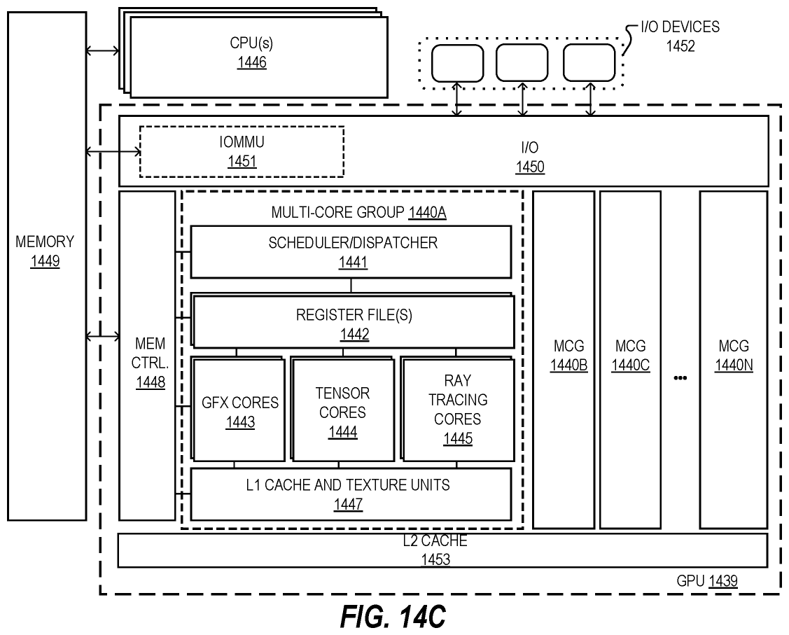

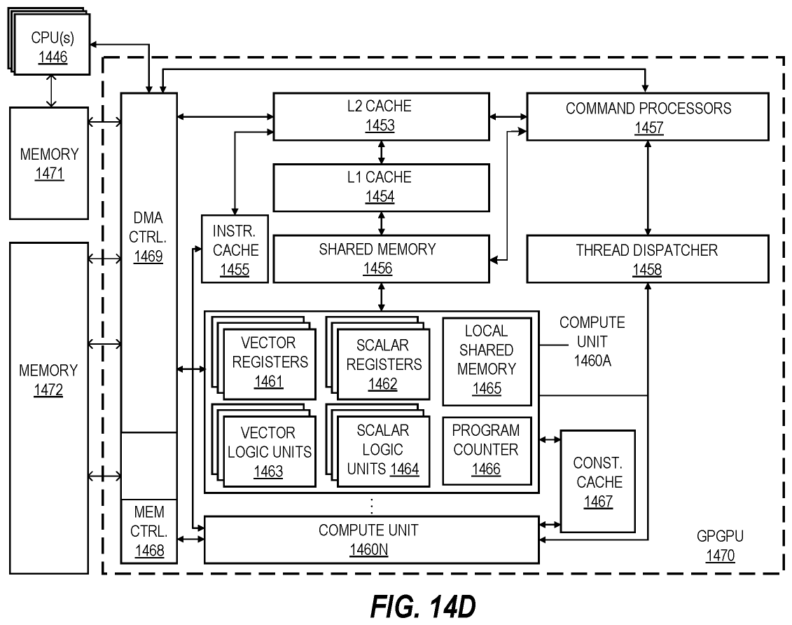

FIGS. 14A-14D illustrate computing systems and graphics processors provided by embodiments described herein. The elements of FIGS. 14A-14D having the same reference numbers (or names) as the elements of any other figure herein can operate or function in any manner similar to that described elsewhere herein, but are not limited to such.

FIG. 14A is a block diagram of an embodiment of a processor 1400 having one or more processor cores 1402A-1402N, an integrated memory controller 1414, and an integrated graphics processor 1408. Processor 1400 can include additional cores up to and including additional core 1402N represented by the dashed lined boxes. Each of processor cores 1402A-1402N includes one or more internal cache units 1404A-204N. In some embodiments each processor core also has access to one or more shared cached units 1406. The internal cache units 1404A-1404N and shared cache units 1406 represent a cache memory hierarchy within the processor 1400. The cache memory hierarchy may include at least one level of instruction and data cache within each processor core and one or more levels of shared mid-level cache, such as a Level 2 (L2), Level 3(L3), Level 4 (L4), or other levels of cache, where the highest level of cache before external memory is classified as the LLC. In some embodiments, cache coherency logic maintains coherency between the various cache units 1406 and 1404A-1404N.

In some embodiments, processor 1400 may also include a set of one or more bus controller units 1416 and a system agent core 1410. The one or more bus controller units 1416 manage a set of peripheral buses, such as one or more PCI or PCI express busses. System agent core 1410 provides management functionality for the various processor components. In some embodiments, system agent core 1410 includes one or more integrated memory controllers 1414 to manage access to various external memory devices (not shown).

In some embodiments, one or more of the processor cores 1402A-1402N include support for simultaneous multi-threading. In such embodiment, the system agent core 1410 includes components for coordinating and operating cores 1402A-1402N during multi-threaded processing. System agent core 1410 may additionally include a power control unit (PCU), which includes logic and components to regulate the power state of processor cores 1402A-1402N and graphics processor 1408.

In some embodiments, processor 1400 additionally includes graphics processor 1408 to execute graphics processing operations. In some embodiments, the graphics processor 1408 couples with the set of shared cache units 1406, and the system agent core 1410, including the one or more integrated memory controllers 1414. In some embodiments, the system agent core 1410 also includes a display controller 1411 to drive graphics processor output to one or more coupled displays. In some embodiments, display controller 1411 may also be a separate module coupled with the graphics processor via at least one interconnect, or may be integrated within the graphics processor 1408.

In some embodiments, a ring-based interconnect 1412 is used to couple the internal components of the processor 1400. However, an alternative interconnect unit may be used, such as a point-to-point interconnect, a switched interconnect, a mesh interconnect, or other techniques, including techniques well known in the art. In some embodiments, graphics processor 1408 couples with the ring-based interconnect 1412 via an I/O link 1413.

The exemplary I/O link 1413 represents at least one of multiple varieties of I/O interconnects, including an on package I/O interconnect which facilitates communication between various processor components and a high-performance embedded memory module 1418, such as an eDRAM module or a high-bandwidth memory (HBM) module. In some embodiments, each of the processor cores 1402A-1402N and graphics processor 1408 can use the embedded memory module 1418 as a shared Last Level Cache.

In some embodiments, processor cores 1402A-1402N are homogenous cores executing the same instruction set architecture. In another embodiment, processor cores 1402A-1402N are heterogeneous in terms of instruction set architecture (ISA), where one or more of processor cores 1402A-1402N execute a first instruction set, while at least one of the other cores executes a subset of the first instruction set or a different instruction set. In one embodiment, processor cores 1402A-1402N are heterogeneous in terms of microarchitecture, where one or more cores having a relatively higher power consumption couple with one or more power cores having a lower power consumption. In one embodiment, processor cores 1402A-1402N are heterogeneous in terms of computational capability. Additionally, processor 1400 can be implemented on one or more chips or as an SoC integrated circuit having the illustrated components, in addition to other components.

FIG. 2B is a block diagram of hardware logic of a graphics processor core block 1419, according to some embodiments described herein. In some embodiments, elements of FIG. 14B having the same reference numbers (or names) as the elements of any other figure herein may operate or function in a manner similar to that described elsewhere herein. The graphics processor core block 1419 is exemplary of one partition of a graphics processor. The graphics processor core block 1419 can be included within the integrated graphics processor 1408 of FIG. 14A or a discrete graphics processor, parallel processor, and/or compute accelerator. A graphics processor as described herein may include multiple graphics core blocks based on target power and performance envelopes. Each graphics processor core block 1419 can include a function block 1430 coupled with multiple graphics cores 1421A-1421F that include modular blocks of fixed function logic and general-purpose programmable logic. The graphics processor core block 1419 also includes shared/cache memory 1436 that is accessible by all graphics cores 1421A-1421F, rasterizer logic 1437, and additional fixed function logic 1438.

In some embodiments, the function block 1430 includes a geometry/fixed function pipeline 1431 that can be shared by all graphics cores in the graphics processor core block 1419. In various embodiments, the geometry/fixed function pipeline 1431 includes a 3D geometry pipeline a video front-end unit, a thread spawner and global thread dispatcher, and a unified return buffer manager, which manages unified return buffers. In one embodiment the function block 1430 also includes a graphics SoC interface 1432, a graphics microcontroller 1433, and a media pipeline 1434. The graphics SoC interface 1432 provides an interface between the graphics processor core block 1419 and other core blocks within a graphics processor or compute accelerator SoC. The graphics microcontroller 1433 is a programmable sub-processor that is configurable to manage various functions of the graphics processor core block 1419, including thread dispatch, scheduling, and pre-emption. The media pipeline 1434 includes logic to facilitate the decoding, encoding, pre-processing, and/or post-processing of multimedia data, including image and video data. The media pipeline 1434 implement media operations via requests to compute or sampling logic within the graphics cores 1421-1421F. One or more pixel backends 1435 can also be included within the function block 1430. The pixel backends 1435 include a cache memory to store pixel color values and can perform blend operations and lossless color compression of rendered pixel data.

In one embodiment the graphics SoC interface 1432 enables the graphics processor core block 1419 to communicate with general-purpose application processor cores (e.g., CPUs) and/or other components within an SoC or a system host CPU that is coupled with the SoC via a peripheral interface. The graphics SoC interface 1432 also enables communication with off-chip memory hierarchy elements such as a shared last level cache memory, system RAM, and/or embedded on-chip or on-package DRAM. The SoC interface 1432 can also enable communication with fixed function devices within the SoC, such as camera imaging pipelines, and enables the use of and/or implements global memory atomics that may be shared between the graphics processor core block 1419 and CPUs within the SoC. The graphics SoC interface 1432 can also implement power management controls for the graphics processor core block 1419 and enable an interface between a clock domain of the graphics processor core block 1419 and other clock domains within the SoC. In one embodiment the graphics SoC interface 1432 enables receipt of command buffers from a command streamer and global thread dispatcher that are configured to provide commands and instructions to each of one or more graphics cores within a graphics processor. The commands and instructions can be dispatched to the media pipeline 1434 when media operations are to be performed, the geometry and fixed function pipeline 1431 when graphics processing operations are to be performed. When compute operations are to be performed, compute dispatch logic can dispatch the commands to the graphics cores 1421A-1421F, bypassing the geometry and media pipelines.

The graphics microcontroller 1433 can be configured to perform various scheduling and management tasks for the graphics processor core block 1419. In one embodiment the graphics microcontroller 1433 can perform graphics and/or compute workload scheduling on the various vector engines 1422A-1422F, 1424A-1424F and matrix engines 1423A-1423F, 1425A-1425F within the graphics cores 1421A-1421F. In this scheduling model, host software executing on a CPU core of an SoC including the graphics processor core block 1419 can submit workloads one of multiple graphic processor doorbells, which invokes a scheduling operation on the appropriate graphics engine. Scheduling operations include determining which workload to run next, submitting a workload to a command streamer, pre-empting existing workloads running on an engine, monitoring progress of a workload, and notifying host software when a workload is complete. In one embodiment the graphics microcontroller 1433 can also facilitate low-power or idle states for the graphics processor core block 1419, providing the graphics processor core block 1419 with the ability to save and restore registers within the graphics processor core block 1419 across low-power state transitions independently from the operating system and/or graphics driver software on the system.

The graphics processor core block 1419 may have greater than or fewer than the illustrated graphics cores 1421A-1421F, up to N modular graphics cores. For each set of N graphics cores, the graphics processor core block 1419 can also include shared/cache memory 1436, which can be configured as shared memory or cache memory, rasterizer logic 1437, and additional fixed function logic 1438 to accelerate various graphics and compute processing operations.

Within each graphics cores 1421A-1421F is set of execution resources that may be used to perform graphics, media, and compute operations in response to requests by graphics pipeline, media pipeline, or shader programs. The graphics cores 1421A-1421F include multiple vector engines 1422A-1422F, 1424A-1424F, matrix acceleration units 1423A-1423F, 1425A-1425D, cache/shared local memory (SLM), a sampler 1426A-1426F, and a ray tracing unit 1427A-1427F.

The vector engines 1422A-1422F, 1424A-1424F are general-purpose graphics processing units capable of performing floating-point and integer/fixed-point logic operations in service of a graphics, media, or compute operation, including graphics, media, or compute/GPGPU programs. The vector engines 1422A-1422F, 1424A-1424F can operate at variable vector widths using SIMD, SIMT, or SIMT+SIMD execution modes. The matrix acceleration units 1423A-1423F, 1425A-1425D include matrix-matrix and matrix-vector acceleration logic that improves performance on matrix operations, particularly low and mixed precision (e.g., INT8,FP16, BF16) matrix operations used for machine learning. In one embodiment, each of the matrix acceleration units 1423A-1423F, 1425A-1425D includes one or more systolic arrays of processing elements that can perform concurrent matrix multiply or dot product operations on matrix elements.

The sampler 1426A-1426F can read media or texture data into memory and can sample data differently based on a configured sampler state and the texture/media format that is being read. Threads executing on the vector engines 1422A-1422F, 1424A-1424F or matrix acceleration units 1423A-1423F, 1425A-1425D can make use of the cache/SLM 1428A-1428F within each execution core. The cache/SLM 1428A-1428F can be configured as cache memory or as a pool of shared memory that is local to each of the respective graphics cores 1421A-1421F. The ray tracing units 1427A-1427F within the graphics cores 1421A-1421F include ray traversal/intersection circuitry for performing ray traversal using bounding volume hierarchies (BVHs) and identifying intersections between rays and primitives enclosed within the BVH volumes. In one embodiment the ray tracing units 1427A-1427F include circuitry for performing depth testing and culling (e.g., using a depth buffer or similar arrangement). In one implementation, the ray tracing units 1427A-1427F perform traversal and intersection operations in concert with image denoising, at least a portion of which may be performed using an associated matrix acceleration unit 1423A-1423F, 1425A-1425D.

FIG. 14C illustrates a graphics processing unit (GPU) 1439 that includes dedicated sets of graphics processing resources arranged into multi-core groups 1440A-1440N. The details of multi-core group 1440A are illustrated. Multi-core groups 1440B-1440N may be equipped with the same or similar sets of graphics processing resources.

As illustrated, a multi-core group 1440A may include a set of graphics cores 1443, a set of tensor cores 1444, and a set of ray tracing cores 1445. A scheduler/dispatcher 1441 schedules and dispatches the graphics threads for execution on the various cores 1443, 1444, 1445. In one embodiment the tensor cores 1444 are sparse tensor cores with hardware to enable multiplication operations having a zero-value input to be bypassed. The graphics cores 1443 of the GPU 1439 of FIG. 14C differ in hierarchical abstraction level relative to the graphics cores 1421A-1421F of FIG. 14B, which are analogous to the multi-core groups 1440A-1440N of FIG. 14C. The graphics cores 1443, tensor cores 1444, and ray tracing cores 1445 of FIG. 14C are analogous to, respectively, the vector engines 1422A-1422F, 1424A-1424F, matrix engines 1423A-1423F, 1425A-1425F, and ray tracing units 1427A-1427F of FIG. 14B.

A set of register files 1442 can store operand values used by the cores 1443, 1444, 1445 when executing the graphics threads. These may include, for example, integer registers for storing integer values, floating point registers for storing floating point values, vector registers for storing packed data elements (integer and/or floating-point data elements) and tile registers for storing tensor/matrix values. In one embodiment, the tile registers are implemented as combined sets of vector registers.

One or more combined level 1 (L1) caches and shared memory units 1447 store graphics data such as texture data, vertex data, pixel data, ray data, bounding volume data, etc., locally within each multi-core group 1440A. One or more texture units 1447 can also be used to perform texturing operations, such as texture mapping and sampling. A Level 2 (L2) cache 1453 shared by all or a subset of the multi-core groups 1440A-1440N stores graphics data and/or instructions for multiple concurrent graphics threads. As illustrated, the L2 cache 1453 may be shared across a plurality of multi-core groups 1440A-1440N. One or more memory controllers 1448 couple the GPU 1439 to a memory 1449 which may be a system memory (e.g., DRAM) and/or a dedicated graphics memory (e.g., GDDR6 memory).

Input/output (I/O) circuitry 1450 couples the GPU 1439 to one or more I/O devices 1452 such as digital signal processors (DSPs), network controllers, or user input devices. An on-chip interconnect may be used to couple the I/O devices 1452 to the GPU 1439 and memory 1449. One or more I/O memory management units (IOMMUs) 1451 of the I/O circuitry 1450 couple the I/O devices 1452 directly to the memory 1449. In one embodiment, the IOMMU 1451 manages multiple sets of page tables to map virtual addresses to physical addresses in memory 1449. In this embodiment, the I/O devices 1452, CPU(s) 1446, and GPU 1439 may share the same virtual address space.

In one implementation, the IOMMU 1451 supports virtualization. In this case, it may manage a first set of page tables to map guest/graphics virtual addresses to guest/graphics physical addresses and a second set of page tables to map the guest/graphics physical addresses to system/host physical addresses (e.g., within memory 1449). The base addresses of each of the first and second sets of page tables may be stored in control registers and swapped out on a context switch (e.g., so that the new context is provided with access to the relevant set of page tables). While not illustrated in FIG. 14C, each of the cores 1443, 1444, 1445 and/or multi-core groups 1440A-1440N may include translation lookaside buffers (TLBs) to cache guest virtual to guest physical translations, guest physical to host physical translations, and guest virtual to host physical translations.

In one embodiment, the CPUs 1446, GPU 1439, and I/O devices 1452 are integrated on a single semiconductor chip and/or chip package. The memory 1449 may be integrated on the same chip or may be coupled to the memory controllers 1448 via an off-chip interface. In one implementation, the memory 1449 comprises GDDR6 memory which shares the same virtual address space as other physical system-level memories, although the underlying principles of the embodiments described herein are not limited to this specific implementation.

In one embodiment, the tensor cores 1444 include a plurality of functional units specifically designed to perform matrix operations, which are the fundamental compute operation used to perform deep learning operations. For example, simultaneous matrix multiplication operations may be used for neural network training and inferencing. The tensor cores 1444 may perform matrix processing using a variety of operand precisions including single precision floating-point (e.g., 32 bits), half-precision floating point (e.g., 16 bits), integer words (16 bits), bytes (8 bits), and half-bytes (4 bits). In one embodiment, a neural network implementation extracts features of each rendered scene, potentially combining details from multiple frames, to construct a high-quality final image.

In deep learning implementations, parallel matrix multiplication work may be scheduled for execution on the tensor cores 1444. The training of neural networks, in particular, requires a significant number of matrix dot product operations. In order to process an inner-product formulation of an N×N×N matrix multiply, the tensor cores 1444 may include at least N dot-product processing elements. Before the matrix multiply begins, one entire matrix is loaded into tile registers and at least one column of a second matrix is loaded each cycle for N cycles. Each cycle, there are N dot products that are processed.

Matrix elements may be stored at different precisions depending on the particular implementation, including 16-bit words, 8-bit bytes (e.g., INT8) and 4-bit half-bytes (e.g., INT4). Different precision modes may be specified for the tensor cores 1444 to ensure that the most efficient precision is used for different workloads (e.g., such as inferencing workloads which can tolerate quantization to bytes and half-bytes).

In one embodiment, the ray tracing cores 1445 accelerate ray tracing operations for both real-time ray tracing and non-real-time ray tracing implementations. In particular, the ray tracing cores 1445 include ray traversal/intersection circuitry for performing ray traversal using bounding volume hierarchies (BVHs) and identifying intersections between rays and primitives enclosed within the BVH volumes. The ray tracing cores 1445 may also include circuitry for performing depth testing and culling (e.g., using a Z buffer or similar arrangement). In one implementation, the ray tracing cores 1445 perform traversal and intersection operations in concert with the image denoising techniques described herein, at least a portion of which may be executed on the tensor cores 1444. For example, in one embodiment, the tensor cores 1444 implement a deep learning neural network to perform denoising of frames generated by the ray tracing cores 1445. However, the CPU(s) 1446, graphics cores 1443, and/or ray tracing cores 1445 may also implement all or a portion of the denoising and/or deep learning algorithms.

In addition, as described above, a distributed approach to denoising may be employed in which the GPU 1439 is in a computing device coupled to other computing devices over a network or high-speed interconnect. In this embodiment, the interconnected computing devices share neural network learning/training data to improve the speed with which the overall system learns to perform denoising for different types of image frames and/or different graphics applications.

In one embodiment, the ray tracing cores 1445 process all BVH traversal and ray-primitive intersections, saving the graphics cores 1443 from being overloaded with thousands of instructions per ray. In one embodiment, each ray tracing core 1445 includes a first set of specialized circuitry for performing bounding box tests (e.g., for traversal operations) and a second set of specialized circuitry for performing the ray-triangle intersection tests (e.g., intersecting rays which have been traversed). Thus, in one embodiment, the multi-core group 1440A can simply launch a ray probe, and the ray tracing cores 1445 independently perform ray traversal and intersection and return hit data (e.g., a hit, no hit, multiple hits, etc.) to the thread context. The other cores 1443, 1444 are freed to perform other graphics or compute work while the ray tracing cores 1445 perform the traversal and intersection operations.

In one embodiment, each ray tracing core 1445 includes a traversal unit to perform BVH testing operations and an intersection unit which performs ray-primitive intersection tests. The intersection unit generates a “hit”, “no hit”, or “multiple hit” response, which it provides to the appropriate thread. During the traversal and intersection operations, the execution resources of the other cores (e.g., graphics cores 1443 and tensor cores 1444) are freed to perform other forms of graphics work.

In one particular embodiment described below, a hybrid rasterization/ray tracing approach is used in which work is distributed between the graphics cores 1443 and ray tracing cores 1445.

In one embodiment, the ray tracing cores 1445 (and/or other cores 1443, 1444) include hardware support for a ray tracing instruction set such as Microsoft's DirectX Ray Tracing (DXR) which includes a DispatchRays command, as well as ray-generation, closest-hit, any-hit, and miss shaders, which enable the assignment of unique sets of shaders and textures for each object. Another ray tracing platform which may be supported by the ray tracing cores 1445, graphics cores 1443 and tensor cores 1444 is Vulkan 1.1.85. Note, however, that the underlying principles of the embodiments described herein are not limited to any particular ray tracing ISA.

In general, the various cores 1445, 1444, 1443 may support a ray tracing instruction set that includes instructions/functions for ray generation, closest hit, any hit, ray-primitive intersection, per-primitive and hierarchical bounding box construction, miss, visit, and exceptions. More specifically, one embodiment includes ray tracing instructions to perform the following functions:
Ray Generation—Ray generation instructions may be executed for each pixel, sample, or other user-defined work assignment.
Closest Hit—A closest hit instruction may be executed to locate the closest intersection point of a ray with primitives within a scene.
Any Hit—An any hit instruction identifies multiple intersections between a ray and primitives within a scene, potentially to identify a new closest intersection point.
Intersection—An intersection instruction performs a ray-primitive intersection test and outputs a result.
Per—primitive Bounding box Construction-This instruction builds a bounding box around a given primitive or group of primitives (e.g., when building a new BVH or other acceleration data structure).
Miss—Indicates that a ray misses all geometry within a scene, or specified region of a scene.
Visit—Indicates the child volumes a ray will traverse.
Exceptions—Includes various types of exception handlers (e.g., invoked for various error conditions).

In one embodiment the ray tracing cores 1445 may be adapted to accelerate general-purpose compute operations that can be accelerated using computational techniques that are analogous to ray intersection tests. A compute framework can be provided that enables shader programs to be compiled into low level instructions and/or primitives that perform general-purpose compute operations via the ray tracing cores. Exemplary computational problems that can benefit from compute operations performed on the ray tracing cores 1445 include computations involving beam, wave, ray, or particle propagation within a coordinate space. Interactions associated with that propagation can be computed relative to a geometry or mesh within the coordinate space. For example, computations associated with electromagnetic signal propagation through an environment can be accelerated via the use of instructions or primitives that are executed via the ray tracing cores. Diffraction and reflection of the signals by objects in the environment can be computed as direct ray-tracing analogies.

Ray tracing cores 1445 can also be used to perform computations that are not directly analogous to ray tracing. For example, mesh projection, mesh refinement, and volume sampling computations can be accelerated using the ray tracing cores 1445. Generic coordinate space calculations, such as nearest neighbor calculations can also be performed. For example, the set of points near a given point can be discovered by defining a bounding box in the coordinate space around the point. BVH and ray probe logic within the ray tracing cores 1445 can then be used to determine the set of point intersections within the bounding box. The intersections constitute the origin point and the nearest neighbors to that origin point. Computations that are performed using the ray tracing cores 1445 can be performed in parallel with computations performed on the graphics cores 1443 and tensor cores 1444. A shader compiler can be configured to compile a compute shader or other general-purpose graphics processing program into low level primitives that can be parallelized across the graphics cores 1443, tensor cores 1444, and ray tracing cores 1445.

FIG. 14D is a block diagram of general-purpose graphics processing unit (GPGPU) 1470 that can be configured as a graphics processor and/or compute accelerator, according to embodiments described herein. The GPGPU 1470 can interconnect with host processors (e.g., one or more CPU(s) 1446) and memory 1471, 1472 via one or more system and/or memory busses. In one embodiment the memory 1471 is system memory that may be shared with the one or more CPU(s) 1446, while memory 1472 is device memory that is dedicated to the GPGPU 1470. In one embodiment, components within the GPGPU 1470 and memory 1472 may be mapped into memory addresses that are accessible to the one or more CPU(s) 1446. Access to memory 1471 and 1472 may be facilitated via a memory controller 1468. In one embodiment the memory controller 1468 includes an internal direct memory access (DMA) controller 1469 or can include logic to perform operations that would otherwise be performed by a DMA controller.

The GPGPU 1470 includes multiple cache memories, including an L2 cache 1453, L1 cache 1454, an instruction cache 1455, and shared memory 1456, at least a portion of which may also be partitioned as a cache memory. The GPGPU 1470 also includes multiple compute units 1460A-1460N, which represent a hierarchical abstraction level analogous to the graphics cores 1421A-1421F of FIG. 14B and the multi-core groups 1440A-1440N of FIG. 14C. Each compute unit 1460A-1460N includes a set of vector registers 1461, scalar registers 1462, vector logic units 1463, and scalar logic units 1464. The compute units 1460A-1460N can also include local shared memory 1465 and a program counter 1466. The compute units 1460A-1460N can couple with a constant cache 1467, which can be used to store constant data, which is data that will not change during the run of kernel or shader program that executes on the GPGPU 1470. In one embodiment the constant cache 1467 is a scalar data cache and cached data can be fetched directly into the scalar registers 1462.

During operation, the one or more CPU(s) 1446 can write commands into registers or memory in the GPGPU 1470 that has been mapped into an accessible address space. The command processors 1457 can read the commands from registers or memory and determine how those commands will be processed within the GPGPU 1470. A thread dispatcher 1458 can then be used to dispatch threads to the compute units 1460A-1460N to perform those commands. Each compute unit 1460A-1460N can execute threads independently of the other compute units. Additionally, each compute unit 1460A-1460N can be independently configured for conditional computation and can conditionally output the results of computation to memory. The command processors 1457 can interrupt the one or more CPU(s) 1446 when the submitted commands are complete.

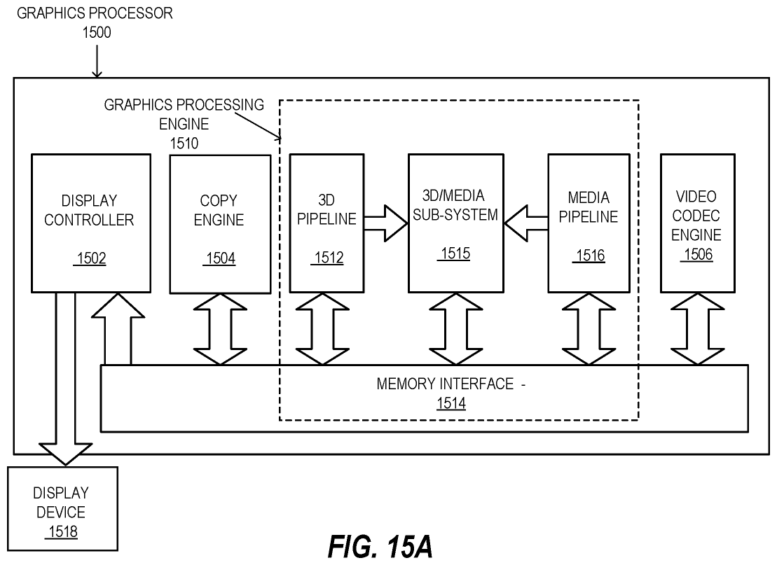

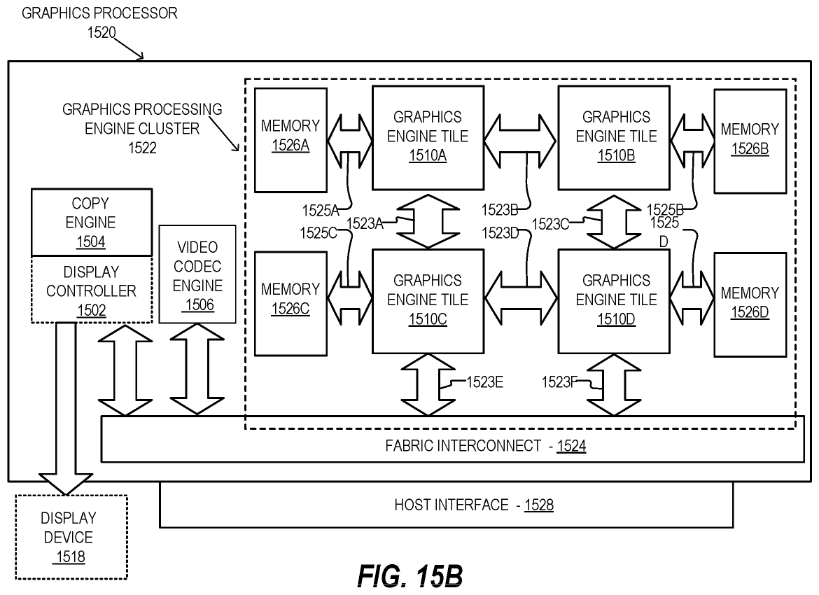

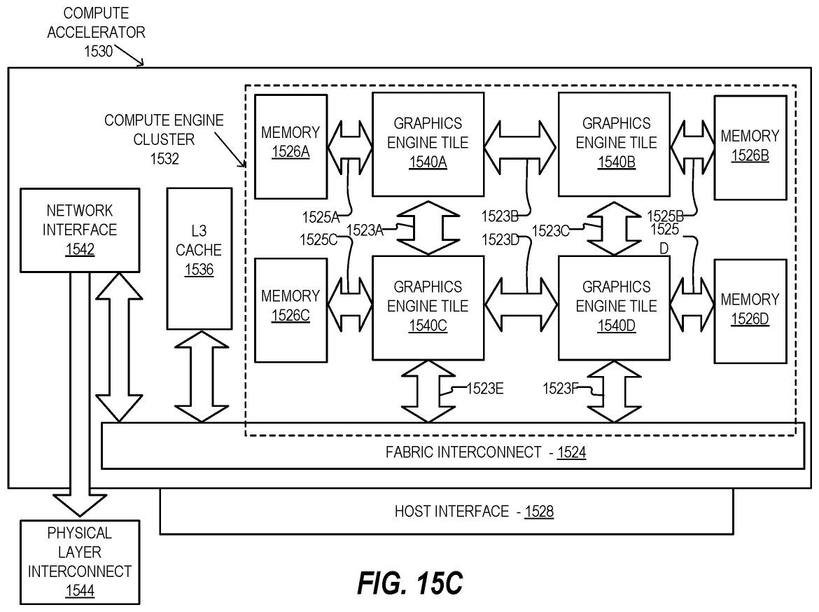

FIGS. 15A-15C illustrate block diagrams of additional graphics processor and compute accelerator architectures provided by embodiments described herein. The elements of FIGS. 15A-15C having the same reference numbers (or names) as the elements of any other figure herein can operate or function in any manner similar to that described elsewhere herein, but are not limited to such.

FIG. 15A is a block diagram of a graphics processor 1500, which may be a discrete graphics processing unit, or may be a graphics processor integrated with a plurality of processing cores, or other semiconductor devices such as, but not limited to, memory devices or network interfaces. In some embodiments, the graphics processor communicates via a memory mapped I/O interface to registers on the graphics processor and with commands placed into the processor memory. In some embodiments, graphics processor 1500 includes a memory interface 1514 to access memory. Memory interface 1514 can be an interface to local memory, one or more internal caches, one or more shared external caches, and/or to system memory.

In some embodiments, graphics processor 1500 also includes a display controller 1502 to drive display output data to a display device 1518. Display controller 1502 includes hardware for one or more overlay planes for the display and composition of multiple layers of video or user interface elements. The display device 1518 can be an internal or external display device. In one embodiment the display device 1518 is a head mounted display device, such as a virtual reality (VR) display device or an augmented reality (AR) display device. In some embodiments, graphics processor 1500 includes a video codec engine 1506 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, H.265/HEVC, Alliance for Open Media (AOMedia) VP8, VP9, as well as the Society of Motion Picture & Television Engineers (SMPTE) 421M/VC-1, and Joint Photographic Experts Group (JPEG) formats such as JPEG, and Motion JPEG (MJPEG) formats.

In some embodiments, graphics processor 1500 includes a block image transfer (BLIT) engine 1504 to perform two-dimensional (2D) rasterizer operations including, for example, bit-boundary block transfers. However, in one embodiment, 2D graphics operations are performed using one or more components of graphics processing engine (GPE) 1510. In some embodiments, GPE 1510 is a compute engine for performing graphics operations, including three-dimensional (3D) graphics operations and media operations.

In some embodiments, GPE 1510 includes a 3D pipeline 1512 for performing 3D operations, such as rendering three-dimensional images and scenes using processing functions that act upon 3D primitive shapes (e.g., rectangle, triangle, etc.). The 3D pipeline 1512 includes programmable and fixed function elements that perform various tasks within the element and/or spawn execution threads to a 3D/Media subsystem 1515. While 3D pipeline 1512 can be used to perform media operations, an embodiment of GPE 1510 also includes a media pipeline 1516 that is specifically used to perform media operations, such as video post-processing and image enhancement.

In some embodiments, media pipeline 1516 includes fixed function or programmable logic units to perform one or more specialized media operations, such as video decode acceleration, video de-interlacing, and video encode acceleration in place of, or on behalf of video codec engine 1506. In some embodiments, media pipeline 1516 additionally includes a thread spawning unit to spawn threads for execution on 3D/Media subsystem 1515. The spawned threads perform computations for the media operations on one or more graphics cores included in 3D/Media subsystem 1515.

In some embodiments, 3D/Media subsystem 1515 includes logic for executing threads spawned by 3D pipeline 1512 and media pipeline 1516. In one embodiment, the pipelines send thread execution requests to 3D/Media subsystem 1515, which includes thread dispatch logic for arbitrating and dispatching the various requests to available thread execution resources. The execution resources include an array of graphics cores to process the 3D and media threads. In some embodiments, 3D/Media subsystem 1515 includes one or more internal caches for thread instructions and data. In some embodiments, the subsystem also includes shared memory, including registers and addressable memory, to share data between threads and to store output data.

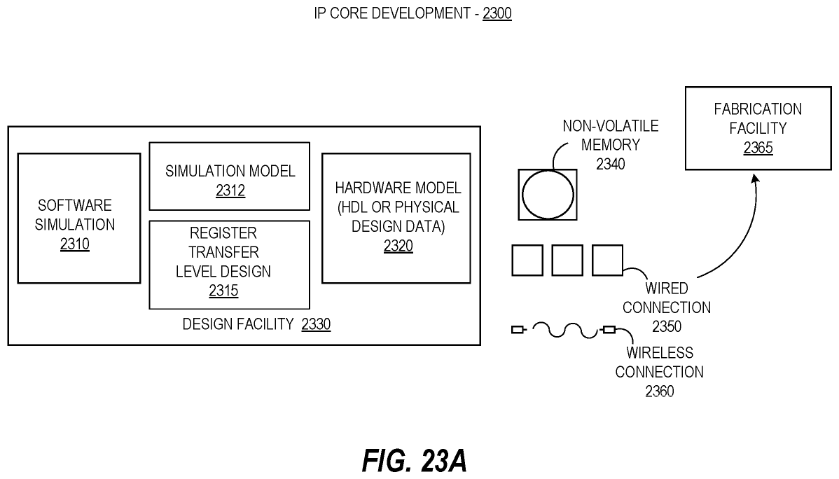

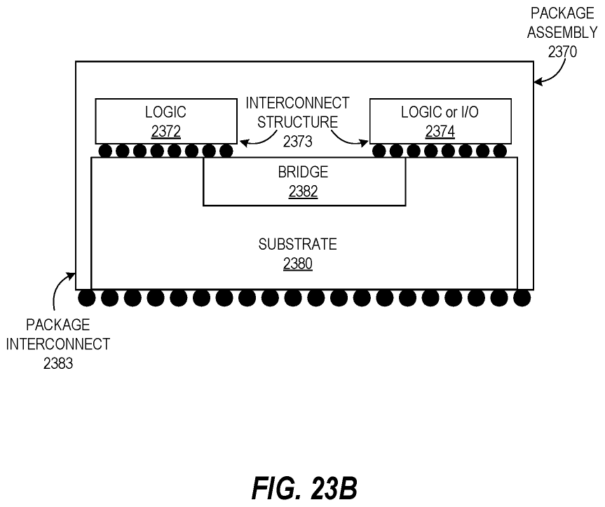

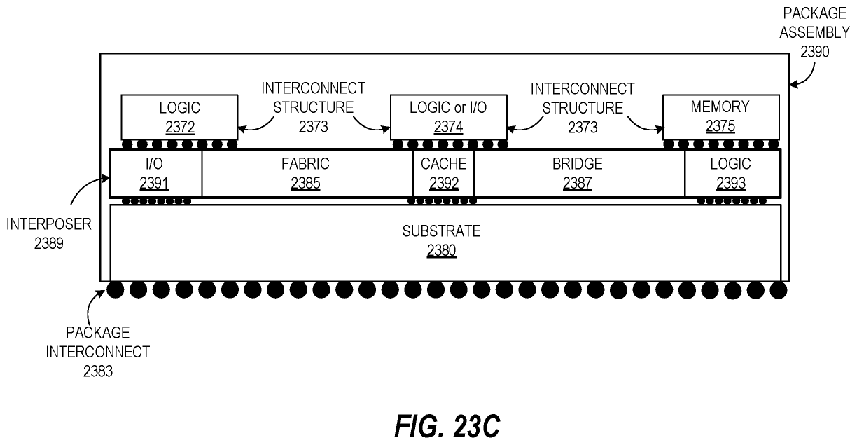

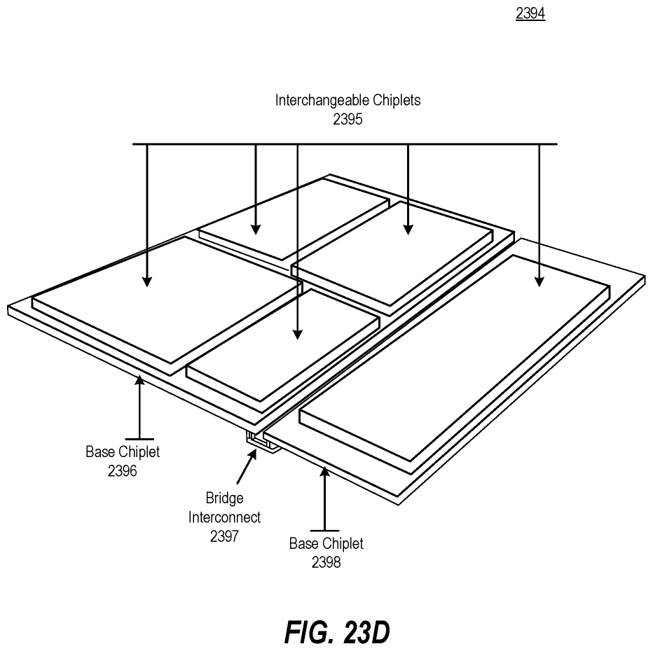

FIG. 15B illustrates a graphics processor 1520 having a tiled architecture, according to embodiments described herein. In one embodiment the graphics processor 1520 includes a graphics processing engine cluster 1522 having multiple instances of the graphics processing engine 1510 of FIG. 15A within a graphics engine tile 1510A-1510D. Each graphics engine tile 1510A-1510D can be interconnected via a set of tile interconnects 1523A-1523F. Each graphics engine tile 1510A-1510D can also be connected to a memory module or memory device 1526A-1526D via memory interconnects 1525A-1525D. The memory devices 1526A-1526D can use any graphics memory technology. For example, the memory devices 1526A-1526D may be graphics double data rate (GDDR) memory. The memory devices 1526A-1526D, in one embodiment, are HBM modules that can be on-die with their respective graphics engine tile 1510A-1510D. In one embodiment the memory devices 1526A-1526D are stacked memory devices that can be stacked on top of their respective graphics engine tile 1510A-1510D. In one embodiment, each graphics engine tile 1510A-1510D and associated memory 1526A-1526D reside on separate chiplets, which are bonded to a base die or base substrate, as described on further detail in FIGS. 23B-23D.

The graphics processor 1520 may be configured with a non-uniform memory access (NUMA) system in which memory devices 1526A-1526D are coupled with associated graphics engine tiles 1510A-1510D. A given memory device may be accessed by graphics engine tiles other than the tile to which it is directly connected. However, access latency to the memory devices 1526A-1526D may be lowest when accessing a local tile. In one embodiment, a cache coherent NUMA (ccNUMA) system is enabled that uses the tile interconnects 1523A-1523F to enable communication between cache controllers within the graphics engine tiles 1510A-1510D to maintain a consistent memory image when more than one cache stores the same memory location.

The graphics processing engine cluster 1522 can connect with an on-chip or on-package fabric interconnect 1524. In one embodiment the fabric interconnect 1524 includes a network processor, network on a chip (NoC), or another switching processor to enable the fabric interconnect 1524 to act as a packet switched fabric interconnect that switches data packets between components of the graphics processor 1520. The fabric interconnect 1524 can enable communication between graphics engine tiles 1510A-1510D and components such as the video codec engine 1506 and one or more copy engines 1504. The copy engines 1504 can be used to move data out of, into, and between the memory devices 1526A-1526D and memory that is external to the graphics processor 1520 (e.g., system memory). The fabric interconnect 1524 can also couple with one or more of the tile interconnects 1523A-1523F to facilitate or enhance the interconnection between the graphics engine tiles 1510A-1510D. The fabric interconnect 1524 is also configurable to interconnect multiple instances of the graphics processor 1520 (e.g., via the host interface 1528), enabling tile-to-tile communication between graphics engine tiles 1510A-1510D of multiple GPUs. In one embodiment, the graphics engine tiles 1510A-1510D of multiple GPUs can be presented to a host system as a single logical device.

The graphics processor 1520 may optionally include a display controller 1502 to enable a connection with the display device 1518. The graphics processor may also be configured as a graphics or compute accelerator. In the accelerator configuration, the display controller 1502 and display device 1518 may be omitted.

The graphics processor 1520 can connect to a host system via a host interface 1528. The host interface 1528 can enable communication between the graphics processor 1520, system memory, and/or other system components. The host interface 1528 can be, for example a PCI express bus or another type of host system interface. For example, the host interface 1528 may be an NVLink or NVSwitch interface. The host interface 1528 and fabric interconnect 1524 can cooperate to enable multiple instances of the graphics processor 1520 to act as single logical device. Cooperation between the host interface 1528 and fabric interconnect 1524 can also enable the individual graphics engine tiles 1510A-1510D to be presented to the host system as distinct logical graphics devices.

FIG. 15C illustrates a compute accelerator 1530, according to embodiments described herein. The compute accelerator 1530 can include architectural similarities with the graphics processor 1520 of FIG. 15B and is optimized for compute acceleration. A compute engine cluster 1532 can include a set of compute engine tiles 1540A-1540D that include execution logic that is optimized for parallel or vector-based general-purpose compute operations. In some embodiments, the compute engine tiles 1540A-1540D do not include fixed function graphics processing logic, although in one embodiment one or more of the compute engine tiles 1540A-1540D can include logic to perform media acceleration. The compute engine tiles 1540A-1540D can connect to memory 1526A-1526D via memory interconnects 1525A-1525D. The memory 1526A-1526D and memory interconnects 1525A-1525D may be similar technology as in graphics processor 1520 or can be different. The graphics compute engine tiles 1540A-1540D can also be interconnected via a set of tile interconnects 1523A-1523F and may be connected with and/or interconnected by a fabric interconnect 1524. Cross-tile communications can be facilitated via the fabric interconnect 1524. The fabric interconnect 1524 (e.g., via the host interface 1528) can also facilitate communication between compute engine tiles 1540A-1540D of multiple instances of the compute accelerator 1530. In one embodiment the compute accelerator 1530 includes a large L3 cache 1536 that can be configured as a device-wide cache. The compute accelerator 1530 can also connect to a host processor and memory via a host interface 1528 in a similar manner as the graphics processor 1520 of FIG. 15B.

The compute accelerator 1530 can also include an integrated network interface 1542. In one embodiment the network interface 1542 includes a network processor and controller logic that enables the compute engine cluster 1532 to communicate over a physical layer interconnect 1544 without requiring data to traverse memory of a host system. In one embodiment, one of the compute engine tiles 1540A-1540D is replaced by network processor logic and data to be transmitted or received via the physical layer interconnect 1544 may be transmitted directly to or from memory 1526A-1526D. Multiple instances of the compute accelerator 1530 may be joined via the physical layer interconnect 1544 into a single logical device. Alternatively, the various compute engine tiles 1540A-1540D may be presented as distinct network accessible compute accelerator devices.

### Graphics Processing Engine

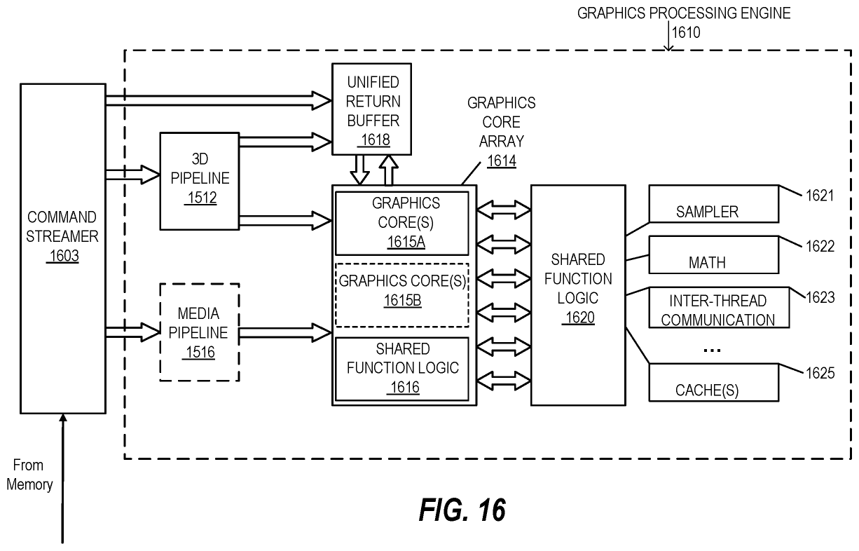

FIG. 16 is a block diagram of a graphics processing engine 1610 of a graphics processor in accordance with some embodiments. In one embodiment, the graphics processing engine (GPE) 1610 is a version of the GPE 1510 shown in FIG. 15A and may also represent a graphics engine tile 1510A-1510D of FIG. 15B. Elements of FIG. 16 having the same reference numbers (or names) as the elements of any other figure herein can operate or function in any manner similar to that described elsewhere herein, but are not limited to such. For example, the 3D pipeline 1512 and media pipeline 1516 of FIG. 15A are illustrated. The media pipeline 1516 is optional in some embodiments of the GPE 1610 and may not be explicitly included within the GPE 1610. For example and in at least one embodiment, a separate media and/or image processor is coupled to the GPE 1610.

In some embodiments, GPE 1610 couples with or includes a command streamer 1603, which provides a command stream to the 3D pipeline 1512 and/or media pipelines 1516. Alternatively or additionally, the command streamer 1603 may be directly coupled to a unified return buffer 1618. The unified return buffer 1618 may be communicatively coupled to a graphics core cluster 1614. In some embodiments, command streamer 1603 is coupled with memory, which can be system memory, or one or more of internal cache memory and shared cache memory. In some embodiments, command streamer 1603 receives commands from the memory and sends the commands to 3D pipeline 1512 and/or media pipeline 1516. The commands are directives fetched from a ring buffer, which stores commands for the 3D pipeline 1512 and media pipeline 1516. In one embodiment, the ring buffer can additionally include batch command buffers storing batches of multiple commands. The commands for the 3D pipeline 1512 can also include references to data stored in memory, such as but not limited to vertex and geometry data for the 3D pipeline 1512 and/or image data and memory objects for the media pipeline 1516. The 3D pipeline 1512 and media pipeline 1516 process the commands and data by performing operations via logic within the respective pipelines or by dispatching one or more execution threads to a graphics core cluster 1614. In one embodiment the graphics core cluster 1614 include one or more blocks of graphics cores (e.g., graphics core block 1615A, graphics core block 1615B), each block including one or more graphics cores. Each graphics core includes a set of graphics execution resources that includes general-purpose and graphics specific execution logic to perform graphics and compute operations, as well as fixed function texture processing and/or machine learning and artificial intelligence acceleration logic, such as matrix or AI acceleration logic.

In various embodiments the 3D pipeline 1512 can include fixed function and programmable logic to process one or more shader programs, such as vertex shaders, geometry shaders, pixel shaders, fragment shaders, compute shaders, or other shader and/or GPGPU programs, by processing the instructions and dispatching execution threads to the graphics core cluster 1614. The graphics core cluster 1614 provides a unified block of execution resources for use in processing these shader programs. Multi-purpose execution logic within the graphics core blocks 1615A-1615B of the graphics core cluster 1614 includes support for various 3D API shader languages and can execute multiple simultaneous execution threads associated with multiple shaders.

In some embodiments, the graphics core cluster 1614 includes execution logic to perform media functions, such as video and/or image processing. In one embodiment, the graphics cores include general-purpose logic that is programmable to perform parallel general-purpose computational operations, in addition to graphics processing operations. The general-purpose logic can perform processing operations in parallel or in conjunction with general-purpose logic within the processor core(s) 1307 of FIG. 13 or core 1402A-1402N as in FIG. 14A.

Output data generated by threads executing on the graphics core cluster 1614 can output data to memory in a unified return buffer (URB) 1618. The URB 1618 can store data for multiple threads. In some embodiments the URB 1618 may be used to send data between different threads executing on the graphics core cluster 1614. In some embodiments the URB 1618 may additionally be used for synchronization between threads on the graphics core array and fixed function logic within the shared function logic 1620.

In some embodiments, graphics core cluster 1614 is scalable, such that the cluster includes a variable number of graphics cores, each having a variable number of graphics cores based on the target power and performance level of GPE 1610. In one embodiment the execution resources are dynamically scalable, such that execution resources may be enabled or disabled as needed.

The graphics core cluster 1614 couples with shared function logic 1620 that includes multiple resources that are shared between the graphics cores in the graphics core array. The shared functions within the shared function logic 1620 are hardware logic units that provide specialized supplemental functionality to the graphics core cluster 1614. In various embodiments, shared function logic 1620 may include, but is not limited to sampler 1621, math 1622, and inter-thread communication (ITC) 1623 logic. Additionally, some embodiments implement one or more cache(s) 1625 within the shared function logic 1620. The shared function logic 1620 can implement the same or similar functionality as the additional fixed function logic 11638 of FIG. 116B.

A shared function is implemented at least in a case where the demand for a given specialized function is insufficient for inclusion within the graphics core cluster 1614. Instead, a single instantiation of that specialized function is implemented as a stand-alone entity in the shared function logic 1620 and shared among the execution resources within the graphics core cluster 1614. The precise set of functions that are shared between the graphics core cluster 1614 and included within the graphics core cluster 1614 varies across embodiments. In some embodiments, specific shared functions within the shared function logic 1620 that are used extensively by the graphics core cluster 1614 may be included within shared function logic 1616 within the graphics core cluster 1614. In various embodiments, the shared function logic 1616 within the graphics core cluster 1614 can include some or all logic within the shared function logic 1620. In one embodiment, all logic elements within the shared function logic 1620 may be duplicated within the shared function logic 1616 of the graphics core cluster 1614. In one embodiment the shared function logic 1620 is excluded in favor of the shared function logic 1616 within the graphics core cluster 1614.

### Graphics Processing Resources

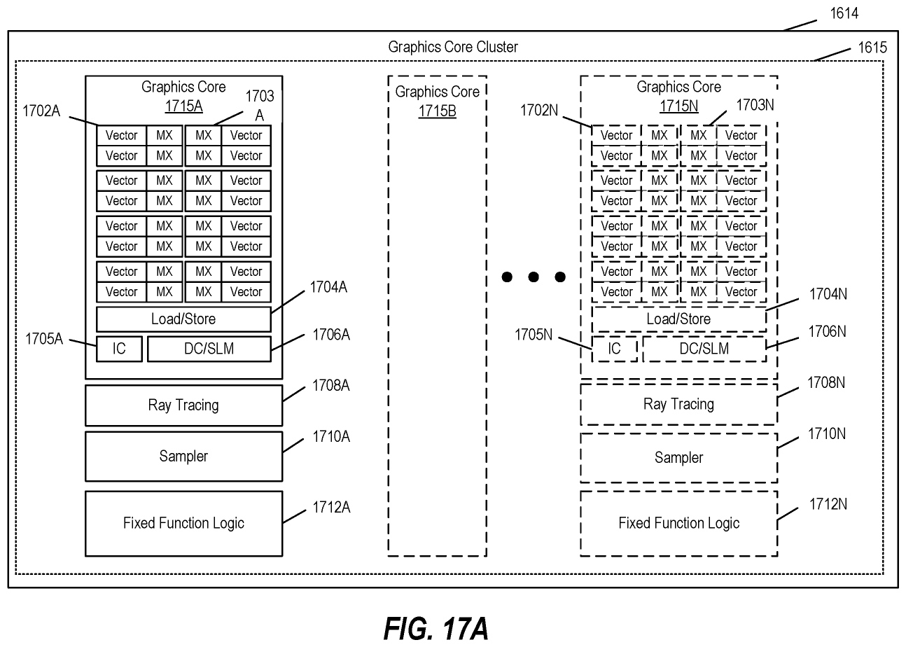

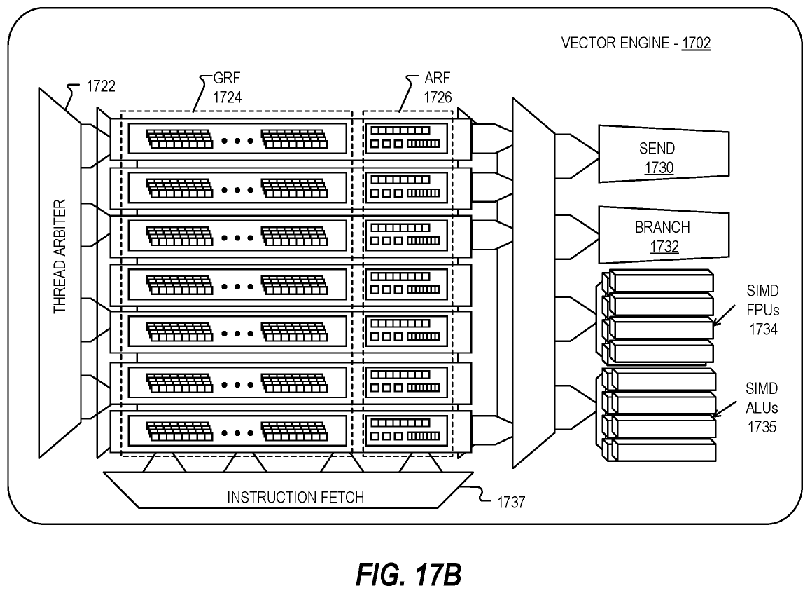

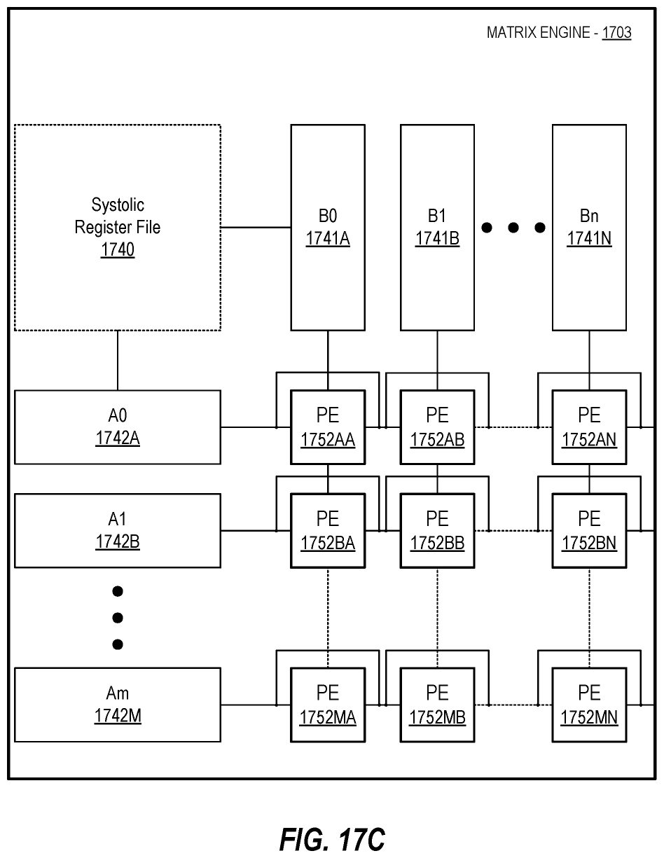

FIG. 17A-17C illustrate execution logic including an array of processing elements employed in a graphics processor, according to embodiments described herein. FIG. 17A illustrates graphics core cluster, according to an embodiment. FIG. 17B illustrates a vector engine of a graphics core, according to an embodiment. FIG. 17C illustrates a matrix engine of a graphics core, according to an embodiment. Elements of FIG. 17A-17C having the same reference numbers as the elements of any other figure herein may operate or function in any manner similar to that described elsewhere herein, but are not limited as such. For example, the elements of FIG. 17A-17C can be considered in the context of the graphics processor core block 1419 of FIG. 14B, and/or the graphics core blocks 1615A-1615B of FIG. 16. In one embodiment, the elements of FIG. 17A-17C have similar functionality to equivalent components of the graphics processor 1408 of FIG. 14A, the GPU 1439 of FIG. 14C or the GPGPU 1470 of FIG. 14D.

As shown in FIG. 17A, in one embodiment the graphics core cluster 1614 includes a graphics core block 1615, which may be graphics core block 1615A or graphics core block 1615B of FIG. 16. The graphics core block 1615 can include any number of graphics cores (e.g., graphics core 1715A, graphics core 1715B, through graphics core 1715N). Multiple instances of the graphics core block 1615 may be included. In one embodiment the elements of the graphics cores 1715A-1715N have similar or equivalent functionality as the elements of the graphics cores 1421A-1421F of FIG. 14B. In such embodiment, the graphics cores 1715A-1715N each include circuitry including but not limited to vector engines 1702A-1702N, matrix engines 1703A-1703N, memory load/store units 1704A-1704N, instruction caches 1705A-1705N, data caches/shared local memory 1706A-1706N, ray tracing units 1708A-1708N, samplers 1710A-1710N. The circuitry of the graphics cores 1715A-1715N can additionally include fixed function logic 1712A-1712N. The number of vector engines 1702A-1702N and matrix engines 1703A-1703N within the graphics cores 1715A-1715N of a design can vary based on the workload, performance, and power targets for the design.

With reference to graphics core 1715A, the vector engine 1702A and matrix engine 1703A are configurable to perform parallel compute operations on data in a variety of integer and floating-point data formats based on instructions associated with shader programs. Each vector engine 1702A and matrix engine 1703A can act as a programmable general-purpose computational unit that is capable of executing multiple simultaneous hardware threads while processing multiple data elements in parallel for each thread. The vector engine 1702A and matrix engine 1703A support the processing of variable width vectors at various SIMD widths, including but not limited to SIMD8, SIMD16, and SIMD32. Input data elements can be stored as a packed data type in a register and the vector engine 1702A and matrix engine 1703A can process the various elements based on the data size of the elements. For example, when operating on a 256-bit wide vector, the 256 bits of the vector are stored in a register and the vector is processed as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible. In one embodiment, the vector engine 1702A and matrix engine 1703A are also configurable for SIMT operation on warps or thread groups of various sizes (e.g., 8, 16, or 32 threads).

Continuing with graphics core 1715A, the memory load/store unit 1704A services memory access requests that are issued by the vector engine 1702A, matrix engine 1703A, and/or other components of the graphics core 1715A that have access to memory. The memory access request can be processed by the memory load/store unit 1704A to load or store the requested data to or from cache or memory into a register file associated with the vector engine 1702A and/or matrix engine 1703A. The memory load/store unit 1704A can also perform prefetching operations. In one embodiment, the memory load/store unit 1704A is configured to provide SIMT scatter/gather prefetching or block prefetching for data stored in memory 1810, from memory that is local to other tiles via the tile interconnect 1808, or from system memory. Prefetching can be performed to a specific L1 cache (e.g., data cache/shared local memory 1706A), the L2 cache 1804 or the L3 cache 1806. In one embodiment, a prefetch to the L3 cache 1806 automatically results in the data being stored in the L2 cache 1804.

The instruction cache 1705A stores instructions to be executed by the graphics core 1715A. In one embodiment, the graphics core 1715A also includes instruction fetch and prefetch circuitry that fetches or prefetches instructions into the instruction cache 1705A. The graphics core 1715A also includes instruction decode logic to decode instructions within the instruction cache 1705A. The data cache/shared local memory 1706A can be configured as a data cache that is managed by a cache controller that implements a cache replacement policy and/or configured as explicitly managed shared memory. The ray tracing unit 1708A includes circuitry to accelerate ray tracing operations. The sampler 1710A provides texture sampling for 3D operations and media sampling for media operations. The fixed function logic 1712A includes fixed function circuitry that is shared between the various instances of the vector engine 1702A and matrix engine 1703A. Graphics cores 1715B-1715N can operate in a similar manner as graphics core 1715A.

Functionality of the instruction caches 1705A-1705N, data caches/shared local memory 1706A-1706N, ray tracing units 1708A-1708N, samplers 1710A-1710N, and fixed function logic 1712A-1712N corresponds with equivalent functionality in the graphics processor architectures described herein. For example, the instruction caches 1705A-1705N can operate in a similar manner as instruction cache 1455 of FIG. 14D. The data caches/shared local memory 1706A-1706N, ray tracing units 1708A-1708N, and samplers 1710A-1710N can operate in a similar manner as the cache/SLM 1428A-1428F, ray tracing units 1427A-1427F, and samplers 1426A-1426F of FIG. 14B. The fixed function logic 1712A-1712N can include elements of the geometry/fixed function pipeline 1431 and/or additional fixed function logic 1438 of FIG. 14B. In one embodiment, the ray tracing units 1708A-1708N include circuitry to perform ray tracing acceleration operations performed by the ray tracing cores 1445 of FIG. 14C.

As shown in FIG. 17B, in one embodiment the vector engine 1702 includes an instruction fetch unit 1737, a general register file array (GRF) 1724, an architectural register file array (ARF) 1726, a thread arbiter 1722, a send unit 1730, a branch unit 1732, a set of SIMD floating point units (FPUs) 1734, and in one embodiment a set of integer SIMD ALUs 1735. The GRF 1724 and ARF 1726 includes the set of general register files and architecture register files associated with each hardware thread that may be active in the vector engine 1702. In one embodiment, per thread architectural state is maintained in the ARF 1726, while data used during thread execution is stored in the GRF 1724. The execution state of each thread, including the instruction pointers for each thread, can be held in thread-specific registers in the ARF 1726.

In one embodiment the vector engine 1702 has an architecture that is a combination of Simultaneous Multi-Threading (SMT) and fine-grained Interleaved Multi-Threading (IMT). The architecture has a modular configuration that can be fine-tuned at design time based on a target number of simultaneous threads and number of registers per graphics core, where graphics core resources are divided across logic used to execute multiple simultaneous threads. The number of logical threads that may be executed by the vector engine 1702 is not limited to the number of hardware threads, and multiple logical threads can be assigned to each hardware thread.

In one embodiment, the vector engine 1702 can co-issue multiple instructions, which may each be different instructions. The thread arbiter 1722 can dispatch the instructions to one of the send unit 1730, branch unit 1732, or SIMD FPU(s) 1734 for execution. Each execution thread can access 128 general-purpose registers within the GRF 1724, where each register can store 32 bytes, accessible as a variable width vector of 32-bit data elements. In one embodiment, each thread has access to 4 Kbytes within the GRF 1724, although embodiments are not so limited, and greater or fewer register resources may be provided in other embodiments. In one embodiment the vector engine 1702 is partitioned into seven hardware threads that can independently perform computational operations, although the number of threads per vector engine 1702 can also vary according to embodiments. For example, in one embodiment up to 16 hardware threads are supported. In an embodiment in which seven threads may access 4 Kbytes, the GRF 1724 can store a total of 28 Kbytes. Where 16 threads may access 4 Kbytes, the GRF 1724 can store a total of 64 Kbytes. Flexible addressing modes can permit registers to be addressed together to build effectively wider registers or to represent strided rectangular block data structures.

In one embodiment, memory operations, sampler operations, and other longer-latency system communications are dispatched via “send” instructions that are executed by the message passing send unit 1730. In one embodiment, branch instructions are dispatched to a dedicated branch unit 1732 to facilitate SIMD divergence and eventual convergence.

In one embodiment the vector engine 1702 includes one or more SIMD floating point units (FPU(s)) 1734 to perform floating-point operations. In one embodiment, the FPU(s) 1734 also support integer computation. In one embodiment the FPU(s) 1734 can execute up to M number of 32-bit floating-point (or integer) operations, or execute up to 2M 16-bit integer or 16-bit floating-point operations. In one embodiment, at least one of the FPU(s) provides extended math capability to support high-throughput transcendental math functions and double precision 64-bit floating-point. In some embodiments, a set of 8-bit integer SIMD ALUs 1735 are also present and may be specifically optimized to perform operations associated with machine learning computations. In one embodiment, the SIMD ALUs are replaced by an additional set of SIMD FPUs 1734 that are configurable to perform integer and floating-point operations. In one embodiment, the SIMD FPUs 1734 and SIMD ALUs 1735 are configurable to execute SIMT programs. In one embodiment, combined SIMD+SIMT operation is supported.

In one embodiment, arrays of multiple instances of the vector engine 1702 can be instantiated in a graphics core. For scalability, product architects can choose the exact number of vector engines per graphics core grouping. In one embodiment the vector engine 1702 can execute instructions across a plurality of execution channels. In a further embodiment, each thread executed on the vector engine 1702 is executed on a different channel.

As shown in FIG. 17C, in one embodiment the matrix engine 1703 includes an array of processing elements that are configured to perform tensor operations including vector/matrix and matrix/matrix operations, such as but not limited to matrix multiply and/or dot product operations. The matrix engine 1703 is configured with M rows and N columns of processing elements (PE 1752AA-PE 1752MN) that include multiplier and adder circuits organized in a pipelined fashion. In one embodiment, the processing elements 1752AA-PE 1752MN make up the physical pipeline stages of an N wide and M deep systolic array that can be used to perform vector/matrix or matrix/matrix operations in a data-parallel manner, including matrix multiply, fused multiply-add, dot product or other general matrix-matrix multiplication (GEMM) operations. In one embodiment the matrix engine 1703 supports 16-bit floating point operations, as well as 8-bit, 4-bit, 2-bit, and binary integer operations. The matrix engine 1703 can also be configured to accelerate specific machine learning operations. In such embodiments, the matrix engine 1703 can be configured with support for the bfloat (brain floating point) 16-bit floating point format or a tensor float 32-bit floating point format (TF32) that have different numbers of mantissa and exponent bits relative to Institute of Electrical and Electronics Engineers (IEEE) 754 formats.

In one embodiment, during each cycle, each stage can add the result of operations performed at that stage to the output of the previous stage. In other embodiments, the pattern of data movement between the processing elements 1752AA-1752MN after a set of computational cycles can vary based on the instruction or macro-operation being performed. For example, in one embodiment partial sum loopback is enabled and the processing elements may instead add the output of a current cycle with output generated in the previous cycle. In one embodiment, the final stage of the systolic array can be configured with a loopback to the initial stage of the systolic array. In such embodiment, the number of physical pipeline stages may be decoupled from the number of logical pipeline stages that are supported by the matrix engine 1703. For example, where the processing elements 1752AA-1752MN are configured as a systolic array of M physical stages, a loopback from stage M to the initial pipeline stage can enable the processing elements 1752AA-PE1752MN to operate as a systolic array of, for example, 2M, 3M, 4M, etc., logical pipeline stages.

In one embodiment, the matrix engine 1703 includes memory 1741A-1741N, 1742A-1742M to store input data in the form of row and column data for input matrices. Memory 1742A-1742M is configurable to store row elements (A0-Am) of a first input matrix and memory 1741A-1741N is configurable to store column elements (B0-Bn) of a second input matrix. The row and column elements are provided as input to the processing elements 1752AA-1752MN for processing. In one embodiment, row and column elements of the input matrices can be stored in a systolic register file 1740 within the matrix engine 1703 before those elements are provided to the memory 1741A-1741N, 1742A-1742M. In one embodiment, the systolic register file 1740 is excluded and the memory 1741A-1741N, 1742A-1742M is loaded from registers in an associated vector engine (e.g., GRF 1724 of vector engine 1702 of FIG. 17B) or other memory of the graphics core that includes the matrix engine 1703 (e.g., data cache/shared local memory 1706A for matrix engine 1703A of FIG. 17A). Results generated by the processing elements 1752AA-1752MN are then output to an output buffer and/or written to a register file (e.g., systolic register file 1740, GRF 1724, data cache/shared local memory 1706A-1706N) for further processing by other functional units of the graphics processor or for output to memory.

In some embodiments, the matrix engine 1703 is configured with support for input sparsity, where multiplication operations for sparse regions of input data can be bypassed by skipping multiply operations that have a zero-value operand. In one embodiment, the processing elements 1752AA-1752MN are configured to skip the performance of certain operations that have zero value input. In one embodiment, sparsity within input matrices can be detected and operations having known zero output values can be bypassed before being submitted to the processing elements 1752AA-1752MN. The loading of zero value operands into the processing elements can be bypassed and the processing elements 1752AA-1752MN can be configured to perform multiplications on the non-zero value input elements. The matrix engine 1703 can also be configured with support for output sparsity, such that operations with results that are pre-determined to be zero are bypassed. For input sparsity and/or output sparsity, in one embodiment, metadata is provided to the processing elements 1752AA-1752MN to indicate, for a processing cycle, which processing elements and/or data channels are to be active during that cycle.

In one embodiment, the matrix engine 1703 includes hardware to enable operations on sparse data having a compressed representation of a sparse matrix that stores non-zero values and metadata that identifies the positions of the non-zero values within the matrix. Exemplary compressed representations include but are not limited to compressed tensor representations such as compressed sparse row (CSR), compressed sparse column (CSC), compressed sparse fiber (CSF) representations. Support for compressed representations enable operations to be performed on input in a compressed tensor format without requiring the compressed representation to be decompressed or decoded. In such embodiment, operations can be performed only on non-zero input values and the resulting non-zero output values can be mapped into an output matrix. In some embodiments, hardware support is also provided for machine-specific lossless data compression formats that are used when transmitting data within hardware or across system busses. Such data may be retained in a compressed format for sparse input data and the matrix engine 1703 can used the compression metadata for the compressed data to enable operations to be performed on only non-zero values, or to enable blocks of zero data input to be bypassed for multiply operations.

In various embodiments, input data can be provided by a programmer in a compressed tensor representation, or a codec can compress input data into the compressed tensor representation or another sparse data encoding. In addition to support for compressed tensor representations, streaming compression of sparse input data can be performed before the data is provided to the processing elements 1752AA-1752MN. In one embodiment, compression is performed on data written to a cache memory associated with the graphics core cluster 414, with the compression being performed with an encoding that is supported by the matrix engine 1703. In one embodiment, the matrix engine 1703 includes support for input having structured sparsity in which a pre-determined level or pattern of sparsity is imposed on input data. This data may be compressed to a known compression ratio, with the compressed data being processed by the processing elements 1752AA-1752MN according to metadata associated with the compressed data.

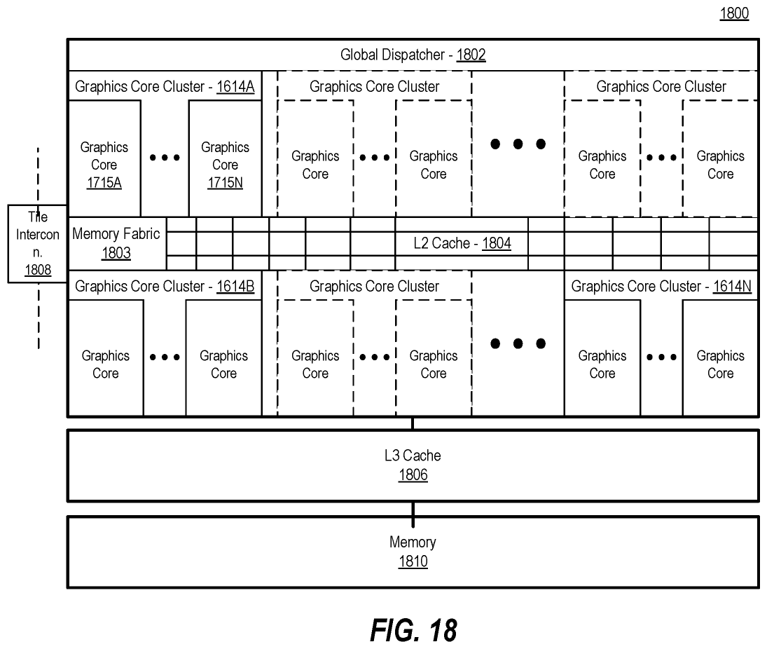

FIG. 18 illustrates a tile 1800 of a multi-tile processor, according to an embodiment. In one embodiment, the tile 1800 is representative of one of the graphics engine tiles 1510A-1510D of FIG. 15B or compute engine tiles 1540A-1540D of FIG. 15C. The tile 1800 of the multi-tile graphics processor includes an array of graphics core clusters (e.g., graphics core cluster 414A, graphics core cluster 414B, through graphics core cluster 414N), with each graphics core cluster having an array of graphics cores 1715A-1715N. The tile 1800 also includes a global dispatcher 1802 to dispatch threads to processing resources of the tile 1800.

The tile 1800 can include or couple with an L3 cache 1806 and memory 1810. In various embodiments, the L3 cache 1806 may be excluded or the tile 1800 can include additional levels of cache, such as an L4 cache. In one embodiment, each instance of the tile 1800 in the multi-tile graphics processor has an associated memory 1810, such as in FIG. 15B and FIG. 15C. In one embodiment, a multi-tile processor can be configured as a multi-chip module in which the L3 cache 1806 and/or memory 1810 reside on separate chiplets than the graphics core clusters 414A-414N. In this context, a chiplet is an at least partially packaged integrated circuit that includes distinct units of logic that can be assembled with other chiplets into a larger package. For example, the L3 cache 1806 can be included in a dedicated cache chiplet or can reside on the same chiplet as the graphics core clusters 414A-414N. In one embodiment, the L3 cache 1806 can be included in an active base die or active interposer, as illustrated in FIG. 11C.

A memory fabric 1803 enables communication among the graphics core clusters 414A-414N, L3 cache 1806, and memory 1810. An L2 cache 1804 couples with the memory fabric 1803 and is configurable to cache transactions performed via the memory fabric 1803. A tile interconnect 1808 enables communication with other tiles on the graphics processors and may be one of tile interconnects 323A-323F of FIG. 3B and 3C. In embodiments in which the L3 cache 1806 is excluded from the tile 1800, the L2 cache 1804 may be configured as a combined L2/L3 cache. The memory fabric 1803 is configurable to route data to the L3 cache 1806 or memory controllers associated with the memory 1810 based on the presence or absence of the L3 cache 1806 in a specific implementation. The L3 cache 1806 can be configured as a per-tile cache that is dedicated to processing resources of the tile 1800 or may be a partition of a GPU-wide L3 cache.

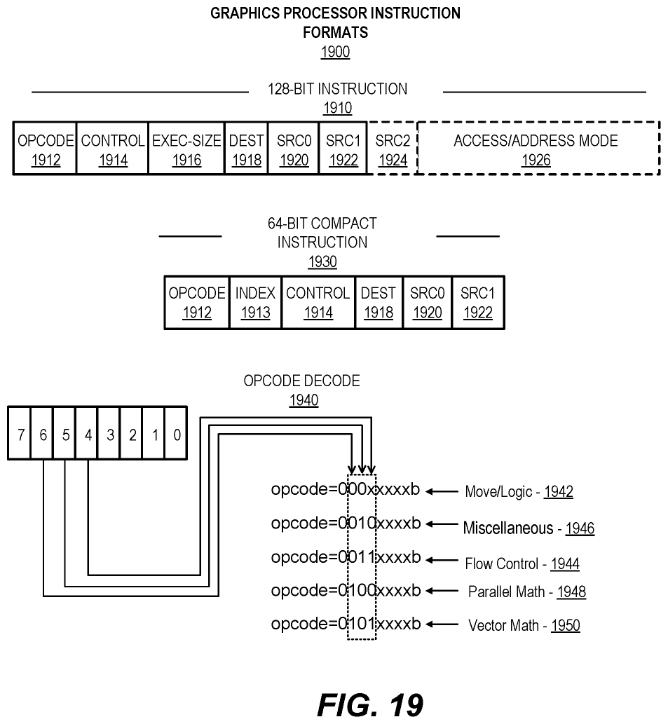

FIG. 19 is a block diagram illustrating graphics processor instruction formats 1900 according to some embodiments. In one or more embodiment, the graphics processor cores support an instruction set having instructions in multiple formats. The solid lined boxes illustrate the components that are generally included in a graphics core instruction, while the dashed lines include components that are optional or that are only included in a sub-set of the instructions. In some embodiments, the graphics processor instruction format 1900 described and illustrated are macro-instructions, in that they are instructions supplied to the graphics core, as opposed to micro-operations resulting from instruction decode once the instruction is processed. Thus, a single instruction may cause hardware to perform multiple micro-operations.

In some embodiments, the graphics processor natively supports instructions in a 128-bit instruction format 1910. A 64-bit compacted instruction format 1930 is available for some instructions based on the selected instruction, instruction options, and number of operands. The native 128-bit instruction format 1910 provides access to all instruction options, while some options and operations are restricted in the 64-bit format 1930. The native instructions available in the 64-bit format 1930 vary by embodiment. In some embodiments, the instruction is compacted in part using a set of index values in an index field 1913. The graphics core hardware references a set of compaction tables based on the index values and uses the compaction table outputs to reconstruct a native instruction in the 128-bit instruction format 1910. Other sizes and formats of instruction can be used.

For each format, instruction opcode 1912 defines the operation that the graphics core is to perform. The graphics cores execute each instruction in parallel across the multiple data elements of each operand. For example, in response to an add instruction the graphics core performs a simultaneous add operation across each color channel representing a texture element or picture element. By default, the graphics core performs each instruction across all data channels of the operands. In some embodiments, instruction control field 1914 enables control over certain execution options, such as channels selection (e.g., predication) and data channel order (e.g., swizzle). For instructions in the 128-bit instruction format 1910 an exec-size field 1916 limits the number of data channels that will be executed in parallel. In some embodiments, exec-size field 1916 is not available for use in the 64-bit compact instruction format 1930.

Some graphics core instructions have up to three operands including two source operands, src0 1920, src1 1922, and one destination 1918. In some embodiments, the graphics cores support dual destination instructions, where one of the destinations is implied. Data manipulation instructions can have a third source operand (e.g., SRC2 1924), where the instruction opcode 1912 determines the number of source operands. An instruction's last source operand can be an immediate (e.g., hard-coded) value passed with the instruction.

In some embodiments, the 128-bit instruction format 1910 includes an access/address mode field 1926 specifying, for example, whether direct register addressing mode or indirect register addressing mode is used. When direct register addressing mode is used, the register address of one or more operands is directly provided by bits in the instruction.

In some embodiments, the 128-bit instruction format 1910 includes an access/address mode field 1926, which specifies an address mode and/or an access mode for the instruction. In one embodiment the access mode is used to define a data access alignment for the instruction. Some embodiments support access modes including a 16-byte aligned access mode and a 1-byte aligned access mode, where the byte alignment of the access mode determines the access alignment of the instruction operands. For example, when in a first mode, the instruction may use byte-aligned addressing for source and destination operands and when in a second mode, the instruction may use 16-byte-aligned addressing for all source and destination operands.

In one embodiment, the address mode portion of the access/address mode field 1926 determines whether the instruction is to use direct or indirect addressing. When direct register addressing mode is used bits in the instruction directly provide the register address of one or more operands. When indirect register addressing mode is used, the register address of one or more operands may be computed based on an address register value and an address immediate field in the instruction.

In some embodiments instructions are grouped based on opcode 1912 bit-fields to simplify Opcode decode 1940. For an 8-bit opcode, bits 4, 5, and 6 allow the graphics core to determine the type of opcode. The precise opcode grouping shown is merely an example. In some embodiments, a move and logic opcode group 1942 includes data movement and logic instructions (e.g., move (mov), compare (cmp)). In some embodiments, move and logic group 1942 shares the five most significant bits (MSB), where move (mov) instructions are in the form of 0000xxxxb and logic instructions are in the form of 0001xxxxb. A flow control instruction group 1944 (e.g., call, jump (jmp)) includes instructions in the form of 0010xxxxb (e.g., 0x20). A miscellaneous instruction group 1946 includes a mix of instructions, including synchronization instructions (e.g., wait, send) in the form of 0011xxxxb (e.g., 0x30). A parallel math instruction group 1948 includes component-wise arithmetic instructions (e.g., add, multiply (mul)) in the form of 0100xxxxb (e.g., 0x40). The parallel math instruction group 1948 performs the arithmetic operations in parallel across data channels. The vector math group 1950 includes arithmetic instructions (e.g., dp4) in the form of 0101xxxxb (e.g., 0x50). The vector math group performs arithmetic such as dot product calculations on vector operands. The illustrated opcode decode 1940, in one embodiment, can be used to determine which portion of a graphics core will be used to execute a decoded instruction. For example, some instructions may be designated as systolic instructions that will be performed by a systolic array. Other instructions, such as ray-tracing instructions (not shown) can be routed to a ray-tracing core or ray-tracing logic within a slice or partition of execution logic.

### Graphics Pipeline

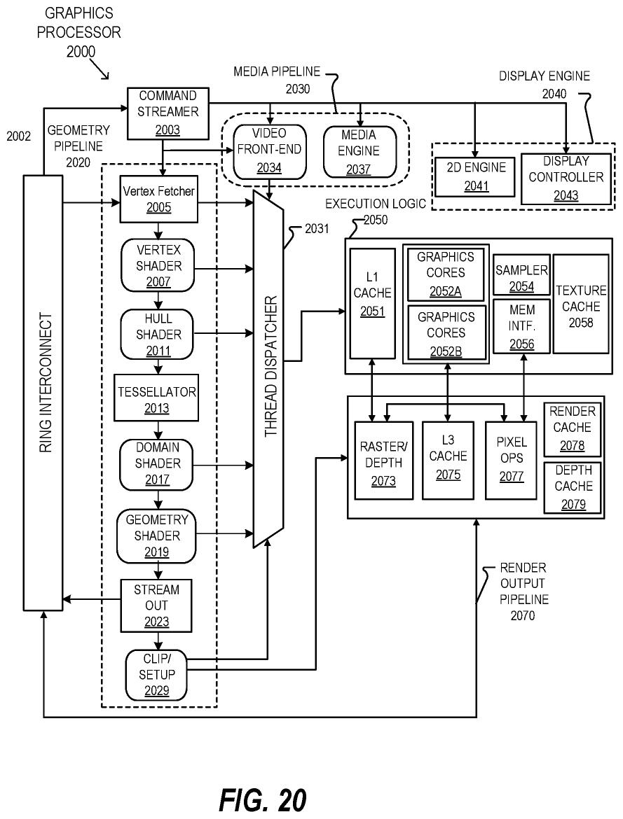

FIG. 20 is a block diagram of another embodiment of a graphics processor 2000. Elements of FIG. 20 having the same reference numbers (or names) as the elements of any other figure herein can operate or function in any manner similar to that described elsewhere herein, but are not limited to such.

In some embodiments, graphics processor 2000 includes a geometry pipeline 2020, a media pipeline 2030, a display engine 2040, thread execution logic 2050, and a render output pipeline 2070. In some embodiments, graphics processor 2000 is a graphics processor within a multi-core processing system that includes one or more general-purpose processing cores. The graphics processor is controlled by register writes to one or more control registers (not shown) or via commands issued to graphics processor 2000 via a ring interconnect 2002. In some embodiments, ring interconnect 2002 couples graphics processor 2000 to other processing components, such as other graphics processors or general-purpose processors. Commands from ring interconnect 2002 are interpreted by a command streamer 2003, which supplies instructions to individual components of the geometry pipeline 2020 or the media pipeline 2030.

In some embodiments, command streamer 2003 directs the operation of a vertex fetcher 2005 that reads vertex data from memory and executes vertex-processing commands provided by command streamer 2003. In some embodiments, vertex fetcher 2005 provides vertex data to a vertex shader 2007, which performs coordinate space transformation and lighting operations to each vertex. In some embodiments, vertex fetcher 2005 and vertex shader 2007 execute vertex-processing instructions by dispatching execution threads to graphics cores 2052A-2052B via a thread dispatcher 2031.

In some embodiments, graphics cores 2052A-2052B are an array of vector processors having an instruction set for performing graphics and media operations. In some embodiments, graphics cores 2052A-2052B have an attached L1 cache 2051 that is specific for each array or shared between the arrays. The cache can be configured as a data cache, an instruction cache, or a single cache that is partitioned to contain data and instructions in different partitions.

In some embodiments, geometry pipeline 2020 includes tessellation components to perform hardware-accelerated tessellation of 3D objects. In some embodiments, a programmable hull shader 2011 configures the tessellation operations. A programmable domain shader 2017 provides back-end evaluation of tessellation output. A tessellator 2013 operates at the direction of hull shader 2011 and contains special purpose logic to generate a set of detailed geometric objects based on a coarse geometric model that is provided as input to geometry pipeline 2020. In some embodiments, if tessellation is not used, tessellation components (e.g., hull shader 2011, tessellator 2013, and domain shader 2017) can be bypassed. The tessellation components can operate based on data received from the vertex shader 2007.

In some embodiments, complete geometric objects can be processed by a geometry shader 2019 via one or more threads dispatched to graphics cores 2052A-2052B or can proceed directly to the clipper 2029. In some embodiments, the geometry shader operates on entire geometric objects, rather than vertices or patches of vertices as in previous stages of the graphics pipeline. If the tessellation is disabled the geometry shader 2019 receives input from the vertex shader 2007. In some embodiments, geometry shader 2019 is programmable by a geometry shader program to perform geometry tessellation if the tessellation units are disabled.

Before rasterization, a clipper 2029 processes vertex data. The clipper 2029 may be a fixed function clipper or a programmable clipper having clipping and geometry shader functions. In some embodiments, a rasterizer and depth test component 2073 in the render output pipeline 2070 dispatches pixel shaders to convert the geometric objects into per pixel representations. In some embodiments, pixel shader logic is included in thread execution logic 2050. In some embodiments, an application can bypass the rasterizer and depth test component 2073 and access un-rasterized vertex data via a stream out unit 2023.

The graphics processor 2000 has an interconnect bus, interconnect fabric, or some other interconnect mechanism that allows data and message passing amongst the major components of the processor. In some embodiments, graphics cores 2052A-2052B and associated logic units (e.g., L1 cache 2051, sampler 2054, texture cache 2058, etc.) interconnect via a data port 2056 to perform memory access and communicate with render output pipeline components of the processor. In some embodiments, sampler 2054, caches 2051, 2058 and graphics cores 2052A-2052B each have separate memory access paths. In one embodiment the texture cache 2058 can also be configured as a sampler cache.

In some embodiments, render output pipeline 2070 contains a rasterizer and depth test component 2073 that converts vertex-based objects into an associated pixel-based representation. In some embodiments, the rasterizer logic includes a windower/masker unit to perform fixed function triangle and line rasterization. An associated render cache 2078 and depth cache 2079 are also available in some embodiments. A pixel operations component 2077 performs pixel-based operations on the data, though in some instances, pixel operations associated with 2D operations (e.g., bit block image transfers with blending) are performed by the 2D engine 2041, or substituted at display time by the display controller 2043 using overlay display planes. In some embodiments, a shared L3 cache 2075 is available to all graphics components, allowing the sharing of data without the use of main system memory.

In some embodiments, media pipeline 2030 includes a media engine 2037 and a video front-end 2034. In some embodiments, video front-end 2034 receives pipeline commands from the command streamer 2003. In some embodiments, media pipeline 2030 includes a separate command streamer. In some embodiments, video front-end 2034 processes media commands before sending the command to the media engine 2037. In some embodiments, media engine 2037 includes thread spawning functionality to spawn threads for dispatch to thread execution logic 2050 via thread dispatcher 2031.

In some embodiments, graphics processor 2000 includes a display engine 2040. In some embodiments, display engine 2040 is external to processor 2000 and couples with the graphics processor via the ring interconnect 2002, or some other interconnect bus or fabric. In some embodiments, display engine 2040 includes a 2D engine 2041 and a display controller 2043. In some embodiments, display engine 2040 contains special purpose logic capable of operating independently of the 3D pipeline. In some embodiments, display controller 2043 couples with a display device (not shown), which may be a system integrated display device, as in a laptop computer, or an external display device attached via a display device connector.

In some embodiments, the geometry pipeline 2020 and media pipeline 2030 are configurable to perform operations based on multiple graphics and media programming interfaces and are not specific to any one application programming interface (API). In some embodiments, driver software for the graphics processor translates API calls that are specific to a particular graphics or media library into commands that can be processed by the graphics processor. In some embodiments, support is provided for the Open Graphics Library (OpenGL), Open Computing Language (OpenCL), and/or Vulkan graphics and compute API, all from the Khronos Group. In some embodiments, support may also be provided for the Direct3D library from the Microsoft Corporation. In some embodiments, a combination of these libraries may be supported. Support may also be provided for the Open Source Computer Vision Library (OpenCV). A future API with a compatible 3D pipeline would also be supported if a mapping can be made from the pipeline of the future API to the pipeline of the graphics processor.

### Graphics Pipeline Programming

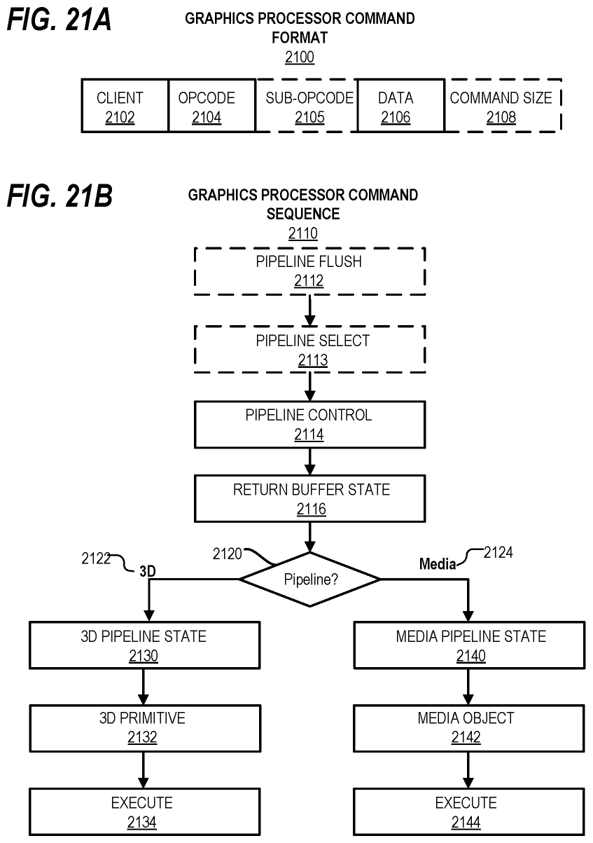

FIG. 21A is a block diagram illustrating a graphics processor command format 2100 that may be used to program graphics processing pipelines according to some embodiments. FIG. 21B is a block diagram illustrating a graphics processor command sequence 2110 according to an embodiment. The solid lined boxes in FIG. 21A illustrate the components that are generally included in a graphics command while the dashed lines include components that are optional or that are only included in a sub-set of the graphics commands. The exemplary graphics processor command format 2100 of FIG. 21A includes data fields to identify a client 2102, a command operation code (opcode) 2104, and a data field 2106 for the command. A sub-opcode 2105 and a command size 2108 are also included in some commands.

In some embodiments, client 2102 specifies the client unit of the graphics device that processes the command data. In some embodiments, a graphics processor command parser examines the client field of each command to condition the further processing of the command and route the command data to the appropriate client unit. In some embodiments, the graphics processor client units include a memory interface unit, a render unit, a 2D unit, a 3D unit, and a media unit. Each client unit has a corresponding processing pipeline that processes the commands. Once the command is received by the client unit, the client unit reads the opcode 2104 and, if present, sub-opcode 2105 to determine the operation to perform. The client unit performs the command using information in data field 2106. For some commands an explicit command size 2108 is expected to specify the size of the command. In some embodiments, the command parser automatically determines the size of at least some of the commands based on the command opcode. In some embodiments commands are aligned via multiples of a double word. Other command formats can be used.

The flow diagram in FIG. 21B illustrates an exemplary graphics processor command sequence 2110. In some embodiments, software or firmware of a data processing system that features an embodiment of a graphics processor uses a version of the command sequence shown to set up, execute, and terminate a set of graphics operations. A sample command sequence is shown and described for purposes of example only as embodiments are not limited to these specific commands or to this command sequence. Moreover, the commands may be issued as batch of commands in a command sequence, such that the graphics processor will process the sequence of commands in at least partially concurrence.

In some embodiments, the graphics processor command sequence 2110 may begin with a pipeline flush command 2112 to cause any active graphics pipeline to complete the currently pending commands for the pipeline. In some embodiments, the 3D pipeline 2122 and the media pipeline 2124 do not operate concurrently. The pipeline flush is performed to cause the active graphics pipeline to complete any pending commands. In response to a pipeline flush, the command parser for the graphics processor will pause command processing until the active drawing engines complete pending operations and the relevant read caches are invalidated. Optionally, any data in the render cache that is marked ‘dirty’ can be flushed to memory. In some embodiments, pipeline flush command 2112 can be used for pipeline synchronization or before placing the graphics processor into a low power state.

In some embodiments, a pipeline select command 2113 is used when a command sequence requires the graphics processor to explicitly switch between pipelines. In some embodiments, a pipeline select command 2113 is required only once within an execution context before issuing pipeline commands unless the context is to issue commands for both pipelines. In some embodiments, a pipeline flush command 2112 is required immediately before a pipeline switch via the pipeline select command 2113.

In some embodiments, a pipeline control command 2114 configures a graphics pipeline for operation and is used to program the 3D pipeline 2122 and the media pipeline 2124. In some embodiments, pipeline control command 2114 configures the pipeline state for the active pipeline. In one embodiment, the pipeline control command 2114 is used for pipeline synchronization and to clear data from one or more cache memories within the active pipeline before processing a batch of commands.

In some embodiments, commands related to the return buffer state 2116 are used to configure a set of return buffers for the respective pipelines to write data. Some pipeline operations require the allocation, selection, or configuration of one or more return buffers into which the operations write intermediate data during processing. In some embodiments, the graphics processor also uses one or more return buffers to store output data and to perform cross thread communication. In some embodiments, the return buffer state 2116 includes selecting the size and number of return buffers to use for a set of pipeline operations.

The remaining commands in the command sequence differ based on the active pipeline for operations. Based on a pipeline determination 2120, the command sequence is tailored to the 3D pipeline 2122 beginning with the 3D pipeline state 2130 or the media pipeline 2124 beginning at the media pipeline state 2140.

The commands to configure the 3D pipeline state 2130 include 3D state setting commands for vertex buffer state, vertex element state, constant color state, depth buffer state, and other state variables that are to be configured before 3D primitive commands are processed. The values of these commands are determined at least in part based on the particular 3D API in use. In some embodiments, 3D pipeline state 2130 commands are also able to selectively disable or bypass certain pipeline elements if those elements will not be used.

In some embodiments, 3D primitive 2132 command is used to submit 3D primitives to be processed by the 3D pipeline. Commands and associated parameters that are passed to the graphics processor via the 3D primitive 2132 command are forwarded to the vertex fetch function in the graphics pipeline. The vertex fetch function uses the 3D primitive 2132 command data to generate vertex data structures. The vertex data structures are stored in one or more return buffers. In some embodiments, 3D primitive 2132 command is used to perform vertex operations on 3D primitives via vertex shaders. To process vertex shaders, 3D pipeline 2122 dispatches shader programs to the graphics cores.

In some embodiments, 3D pipeline 2122 is triggered via an execute 2134 command or event. In some embodiments, a register write triggers command execution. In some embodiments execution is triggered via a ‘go’ or ‘kick’ command in the command sequence. In one embodiment, command execution is triggered using a pipeline synchronization command to flush the command sequence through the graphics pipeline. The 3D pipeline will perform geometry processing for the 3D primitives. Once operations are complete, the resulting geometric objects are rasterized and the pixel engine colors the resulting pixels. Additional commands to control pixel shading and pixel back-end operations may also be included for those operations.

In some embodiments, the graphics processor command sequence 2110 follows the media pipeline 2124 path when performing media operations. In general, the specific use and manner of programming for the media pipeline 2124 depends on the media or compute operations to be performed. Specific media decode operations may be offloaded to the media pipeline during media decode. In some embodiments, the media pipeline can also be bypassed and media decode can be performed in whole or in part using resources provided by one or more general-purpose processing cores. In one embodiment, the media pipeline also includes elements for general-purpose graphics processor unit (GPGPU) operations, where the graphics processor is used to perform SIMD vector operations using computational shader programs that are not explicitly related to the rendering of graphics primitives.

In some embodiments, media pipeline 2124 is configured in a similar manner as the 3D pipeline 2122. A set of commands to configure the media pipeline state 2140 are dispatched or placed into a command queue before the media object commands 2142. In some embodiments, commands for the media pipeline state 2140 include data to configure the media pipeline elements that will be used to process the media objects. This includes data to configure the video decode and video encode logic within the media pipeline, such as encode or decode format. In some embodiments, commands for the media pipeline state 2140 also support the use of one or more pointers to “indirect” state elements that contain a batch of state settings.

In some embodiments, media object commands 2142 supply pointers to media objects for processing by the media pipeline. The media objects include memory buffers containing video data to be processed. In some embodiments, all media pipeline states must be valid before issuing a media object command 2142. Once the pipeline state is configured and media object commands 2142 are queued, the media pipeline 2124 is triggered via an execute command 2144 or an equivalent execute event (e.g., register write). Output from media pipeline 2124 may then be post processed by operations provided by the 3D pipeline 2122 or the media pipeline 2124. In some embodiments, GPGPU operations are configured and executed in a similar manner as media operations.

### Graphics Software Architecture

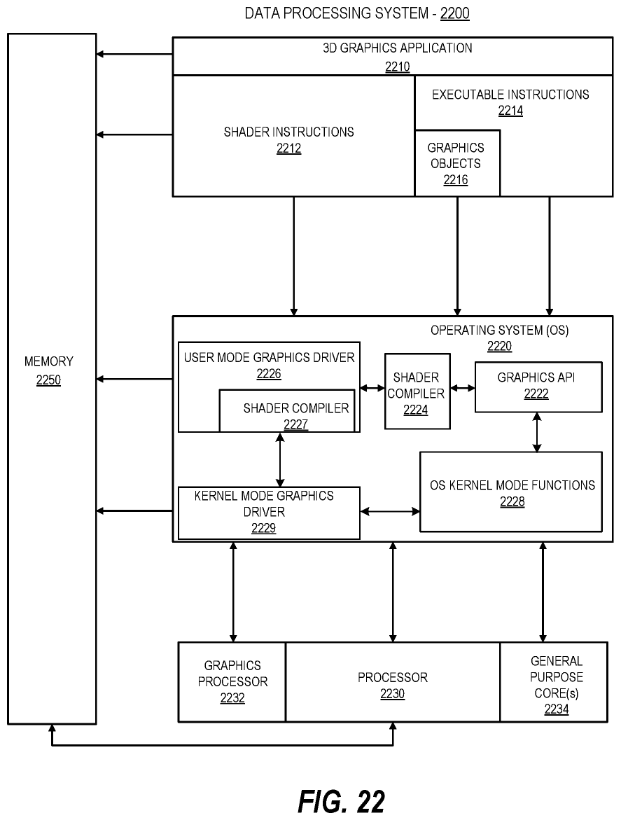

FIG. 22 illustrates an exemplary graphics software architecture for a data processing system 2200 according to some embodiments. In some embodiments, software architecture includes a 3D graphics application 2210, an operating system 2220, and at least one processor 2230. In some embodiments, processor 2230 includes a graphics processor 2232 and one or more general-purpose processor core(s) 2234. The graphics application 2210 and operating system 2220 each execute in the system memory 2250 of the data processing system.

In some embodiments, 3D graphics application 2210 contains one or more shader programs including shader instructions 2212. The shader language instructions may be in a high-level shader language, such as the High-Level Shader Language (HLSL) of Direct3D, the OpenGL Shader Language (GLSL), and so forth. The application also includes executable instructions 2214 in a machine language suitable for execution by the general-purpose processor core 2234. The application also includes graphics objects 2216 defined by vertex data.

In some embodiments, operating system 2220 is a Microsoft® Windows® operating system from the Microsoft Corporation, a proprietary UNIX-like operating system, or an open source UNIX-like operating system using a variant of the Linux kernel. The operating system 2220 can support a graphics API 2222 such as the Direct3D API, the OpenGL API, or the Vulkan API. When the Direct3D API is in use, the operating system 2220 uses a front-end shader compiler 2224 to compile any shader instructions 2212 in HLSL into a lower-level shader language. The compilation may be a just-in-time (JIT) compilation or the application can perform shader pre-compilation. In some embodiments, high-level shaders are compiled into low-level shaders during the compilation of the 3D graphics application 2210. In some embodiments, the shader instructions 2212 are provided in an intermediate form, such as a version of the Standard Portable Intermediate Representation (SPIR) used by the Vulkan API.

In some embodiments, user mode graphics driver 2226 contains a back-end shader compiler 2227 to convert the shader instructions 2212 into a hardware specific representation. When the OpenGL API is in use, shader instructions 2212 in the GLSL high-level language are passed to a user mode graphics driver 2226 for compilation. In some embodiments, user mode graphics driver 2226 uses operating system kernel mode functions 2228 to communicate with a kernel mode graphics driver 2229. In some embodiments, kernel mode graphics driver 2229 communicates with graphics processor 2232 to dispatch commands and instructions.

### IP Core Implementations

One or more aspects of at least one embodiment may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the embodiments described herein.

FIG. 23A is a block diagram illustrating an IP core development system 2300 that may be used to manufacture an integrated circuit to perform operations according to an embodiment. The IP core development system 2300 may be used to generate modular, re-usable designs that can be incorporated into a larger design or used to construct an entire integrated circuit (e.g., an SOC integrated circuit). A design facility 2330 can generate a software simulation 2310 of an IP core design in a high-level programming language (e.g., C/C++). The software simulation 2310 can be used to design, test, and verify the behavior of the IP core using a simulation model 2312. The simulation model 2312 may include functional, behavioral, and/or timing simulations. A register transfer level (RTL) design 2315 can then be created or synthesized from the simulation model 2312. The RTL design 2315 is an abstraction of the behavior of the integrated circuit that models the flow of digital signals between hardware registers, including the associated logic performed using the modeled digital signals. In addition to an RTL design 2315, lower-level designs at the logic level or transistor level may also be created, designed, or synthesized. Thus, the particular details of the initial design and simulation may vary.

The RTL design 2315 or equivalent may be further synthesized by the design facility into a hardware model 2320, which may be in a hardware description language (HDL), or some other representation of physical design data. The HDL may be further simulated or tested to verify the IP core design. The IP core design can be stored for delivery to a 3^{rd} party fabrication facility 2365 using non-volatile memory 2340 (e.g., hard disk, flash memory, or any non-volatile storage medium). Alternatively, the IP core design may be transmitted (e.g., via the Internet) over a wired connection 2350 or wireless connection 2360. The fabrication facility 2365 may then fabricate an integrated circuit that is based at least in part on the IP core design. The fabricated integrated circuit can be configured to perform operations in accordance with at least one embodiment described herein.

FIG. 23B illustrates a cross-section side view of an integrated circuit package assembly 2370, according to some embodiments described herein. The integrated circuit package assembly 2370 illustrates an implementation of one or more processor or accelerator devices as described herein. The package assembly 2370 includes multiple units of hardware logic 2372, 2374 connected to a substrate 2380. The logic 2372, 2374 may be implemented at least partly in configurable logic or fixed-functionality logic hardware, and can include one or more portions of any of the processor core(s), graphics processor(s), or other accelerator devices described herein. Each unit of logic 2372, 2374 can be implemented within a semiconductor die and coupled with the substrate 2380 via an interconnect structure 2373. The interconnect structure 2373 may be configured to route electrical signals between the logic 2372, 2374 and the substrate 2380, and can include interconnects such as, but not limited to bumps or pillars. In some embodiments, the interconnect structure 2373 may be configured to route electrical signals such as, for example, input/output (I/O)) signals and/or power or ground signals associated with the operation of the logic 2372, 2374. In some embodiments, the substrate 2380 is an epoxy-based laminate substrate. The substrate 2380 may include other suitable types of substrates in other embodiments. The package assembly 2370 can be connected to other electrical devices via a package interconnect 2383. The package interconnect 2383 may be coupled to a surface of the substrate 2380 to route electrical signals to other electrical devices, such as a motherboard, other chipset, or multi-chip module.

In some embodiments, the units of logic 2372, 2374 are electrically coupled with a bridge 2382 that is configured to route electrical signals between the logic 2372, 2374. The bridge 2382 may be a dense interconnect structure that provides a route for electrical signals. The bridge 2382 may include a bridge substrate composed of glass or a suitable semiconductor material. Electrical routing features can be formed on the bridge substrate to provide a chip-to-chip connection between the logic 2372, 2374.

Although two units of logic 2372, 2374 and a bridge 2382 are illustrated, embodiments described herein may include more or fewer logic units on one or more dies. The one or more dies may be connected by zero or more bridges, as the bridge 2382 may be excluded when the logic is included on a single die. Alternatively, multiple dies or units of logic can be connected by one or more bridges. Additionally, multiple logic units, dies, and bridges can be connected together in other possible configurations, including three-dimensional configurations.

FIG. 23C illustrates a package assembly 2390 that includes multiple units of hardware logic chiplets connected to a substrate 2380. A graphics processing unit, parallel processor, and/or compute accelerator as described herein can be composed from diverse silicon chiplets that are separately manufactured. A diverse set of chiplets with different IP core logic can be assembled into a single device. Additionally, the chiplets can be integrated into a base die or base chiplet using active interposer technology. The concepts described herein enable the interconnection and communication between the different forms of IP within the GPU. IP cores can be manufactured using different process technologies and composed during manufacturing, which avoids the complexity of converging multiple IPs, especially on a large SoC with several flavors IPs, to the same manufacturing process. Enabling the use of multiple process technologies improves the time to market and provides a cost-effective way to create multiple product SKUs. Additionally, the disaggregated IPs are more amenable to being power gated independently, components that are not in use on a given workload can be powered off, reducing overall power consumption.

In various embodiments a package assembly 2390 can include components and chiplets that are interconnected by a fabric 2385 and/or one or more bridges 2387. The chiplets within the package assembly 2390 may have a 2.5D arrangement using Chip-on-Wafer-on-Substrate stacking in which multiple dies are stacked side-by-side on a silicon interposer 2389 that couples the chiplets with the substrate 2380. The substrate 2380 includes electrical connections to the package interconnect 2383. In one embodiment the silicon interposer 2389 is a passive interposer that includes through-silicon vias (TSVs) to electrically couple chiplets within the package assembly 2390 to the substrate 2380. In one embodiment, silicon interposer 2389 is an active interposer that includes embedded logic in addition to TSVs. In such embodiment, the chiplets within the package assembly 2390 are arranged using 3D face to face die stacking on top of the active interposer 2389. The active interposer 2389 can include hardware logic for I/O 2391, cache memory 2392, and other hardware logic 2393, in addition to interconnect fabric 2385 and a silicon bridge 2387. The fabric 2385 enables communication between the various logic chiplets 2372, 2374 and the logic 2391, 2393 within the active interposer 2389. The fabric 2385 may be an NoC interconnect or another form of packet switched fabric that switches data packets between components of the package assembly. For complex assemblies, the fabric 2385 may be a dedicated chiplet enables communication between the various hardware logic of the package assembly 2390.

Bridge structures 2387 within the active interposer 2389 may be used to facilitate a point-to-point interconnect between, for example, logic or I/O chiplets 2374 and memory chiplets 2375. In some implementations, bridge structures 2387 may also be embedded within the substrate 2380. The hardware logic chiplets can include special purpose hardware logic chiplets 2372, logic or I/O chiplets 2374, and/or memory chiplets 2375. The hardware logic chiplets 2372 and logic or I/O chiplets 2374 may be implemented at least partly in configurable logic or fixed-functionality logic hardware and can include one or more portions of any of the processor core(s), graphics processor(s), parallel processors, or other accelerator devices described herein. The memory chiplets 2375 can be DRAM (e.g., GDDR, HBM) memory or cache (SRAM) memory. Cache memory 2392 within the active interposer 2389 (or substrate 2380) can act as a global cache for the package assembly 2390, part of a distributed global cache, or as a dedicated cache for the fabric 2385.

Each chiplet can be fabricated as separate semiconductor die and coupled with a base die that is embedded within or coupled with the substrate 2380. The coupling with the substrate 2380 can be performed via an interconnect structure 2373. The interconnect structure 2373 may be configured to route electrical signals between the various chiplets and logic within the substrate 2380. The interconnect structure 2373 can include interconnects such as, but not limited to bumps or pillars. In some embodiments, the interconnect structure 2373 may be configured to route electrical signals such as, for example, input/output (I/O) signals and/or power or ground signals associated with the operation of the logic, I/O, and memory chiplets. In one embodiment, an additional interconnect structure couples the active interposer 2389 with the substrate 2380.

In some embodiments, the substrate 2380 is an epoxy-based laminate substrate. The substrate 2380 may include other suitable types of substrates in other embodiments. The package assembly 2390 can be connected to other electrical devices via a package interconnect 2383. The package interconnect 2383 may be coupled to a surface of the substrate 2380 to route electrical signals to other electrical devices, such as a motherboard, other chipset, or multi-chip module.

In some embodiments, a logic or I/O chiplet 2374 and a memory chiplet 2375 can be electrically coupled via a bridge 2387 that is configured to route electrical signals between the logic or I/O chiplet 2374 and a memory chiplet 2375. The bridge 2387 may be a dense interconnect structure that provides a route for electrical signals. The bridge 2387 may include a bridge substrate composed of glass or a suitable semiconductor material. Electrical routing features can be formed on the bridge substrate to provide a chip-to-chip connection between the logic or I/O chiplet 2374 and a memory chiplet 2375. The bridge 2387 may also be referred to as a silicon bridge or an interconnect bridge. For example, the bridge 2387, in some embodiments, is an Embedded Multi-die Interconnect Bridge (EMIB). In some embodiments, the bridge 2387 may simply be a direct connection from one chiplet to another chiplet.

FIG. 23D illustrates a package assembly 2394 including interchangeable chiplets 2395, according to an embodiment. The interchangeable chiplets 2395 can be assembled into standardized slots on one or more base chiplets 2396, 2398. The base chiplets 2396, 2398 can be coupled via a bridge interconnect 2397, which can be similar to the other bridge interconnects described herein and may be, for example, an EMIB. Memory chiplets can also be connected to logic or I/O chiplets via a bridge interconnect. I/O and logic chiplets can communicate via an interconnect fabric. The base chiplets can each support one or more slots in a standardized format for one of logic or I/O or memory/cache.

In one embodiment, SRAM and power delivery circuits can be fabricated into one or more of the base chiplets 2396, 2398, which can be fabricated using a different process technology relative to the interchangeable chiplets 2395 that are stacked on top of the base chiplets. For example, the base chiplets 2396, 2398 can be fabricated using a larger process technology, while the interchangeable chiplets can be manufactured using a smaller process technology. One or more of the interchangeable chiplets 2395 may be memory (e.g., DRAM) chiplets. Different memory densities can be selected for the package assembly 2394 based on the power, and/or performance targeted for the product that uses the package assembly 2394. Additionally, logic chiplets with a different number of type of functional units can be selected at time of assembly based on the power, and/or performance targeted for the product. Additionally, chiplets containing IP logic cores of differing types can be inserted into the interchangeable chiplet slots, enabling hybrid processor designs that can mix and match different technology IP blocks.

### Exemplary System on a Chip Integrated Circuit

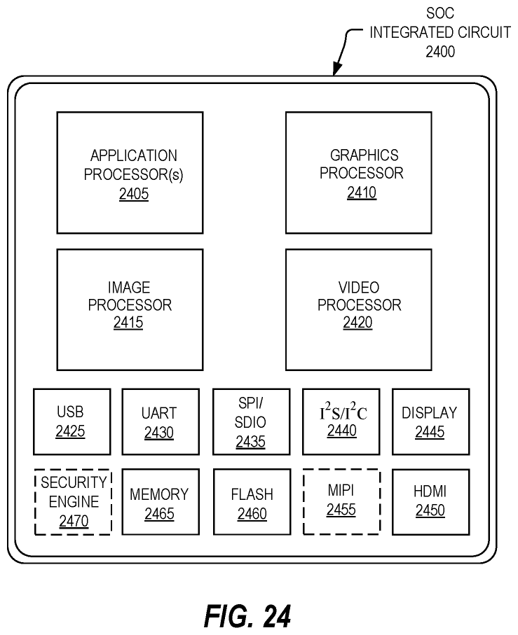

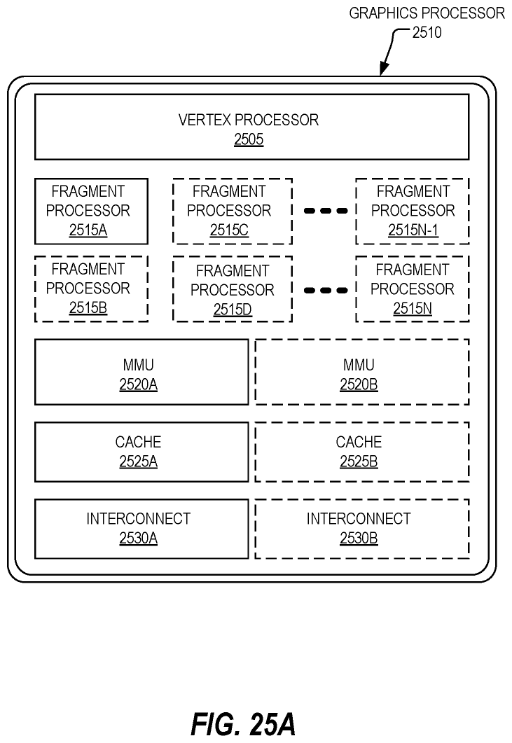

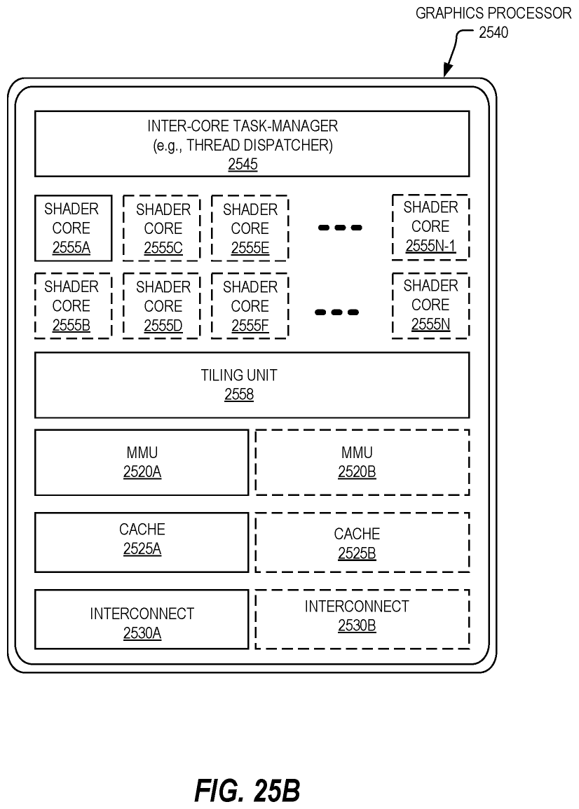

FIGS. 24-25B illustrate exemplary integrated circuits and associated graphics processors that may be fabricated using one or more IP cores, according to various embodiments described herein. In addition to what is illustrated, other logic and circuits may be included, including additional graphics processors/cores, peripheral interface controllers, or general-purpose processor cores.

FIG. 24 is a block diagram illustrating an exemplary system on a chip integrated circuit 2400 that may be fabricated using one or more IP cores, according to an embodiment. Exemplary integrated circuit 2400 includes one or more application processor(s) 2405 (e.g., CPUs), at least one graphics processor 2410, and may additionally include an image processor 2415 and/or a video processor 2420, any of which may be a modular IP core from the same or multiple different design facilities. Integrated circuit 2400 includes peripheral or bus logic including a USB controller 2425, UART controller 2430, an SPI/SDIO controller 2435, and an I2S/I2C controller 2440. Additionally, the integrated circuit can include a display device 2445 coupled to one or more of a high-definition multimedia interface (HDMI) controller 2450 and a mobile industry processor interface (MIPI) display interface 2455. Storage may be provided by a flash memory subsystem 2460 including flash memory and a flash memory controller. Memory interface may be provided via a memory controller 2465 for access to SDRAM or SRAM memory devices. Some integrated circuits additionally include an embedded security engine 2470.

FIGS. 25A-25B are block diagrams illustrating exemplary graphics processors for use within an SoC, according to embodiments described herein. FIG. 25A illustrates an exemplary graphics processor 2510 of a system on a chip integrated circuit that may be fabricated using one or more IP cores, according to an embodiment. FIG. 25B illustrates an additional exemplary graphics processor 2540 of a system on a chip integrated circuit that may be fabricated using one or more IP cores, according to an embodiment. Graphics processor 2510 of FIG. 25A is an example of a low power graphics processor core. Graphics processor 2540 of FIG. 25B is an example of a higher performance graphics processor core. Each of graphics processor 2510 and graphics processor 2540 can be variants of the graphics processor 2410 of FIG. 24.

As shown in FIG. 25A, graphics processor 2510 includes a vertex processor 2505 and one or more fragment processor(s) 2515A-2515N (e.g., 2515A, 2515B, 2515C, 2515D, through 2515N-1, and 2515N). Graphics processor 2510 can execute different shader programs via separate logic, such that the vertex processor 2505 is optimized to execute operations for vertex shader programs, while the one or more fragment processor(s) 2515A-2515N execute fragment (e.g., pixel) shading operations for fragment or pixel shader programs. The vertex processor 2505 performs the vertex processing stage of the 3D graphics pipeline and generates primitives and vertex data. The fragment processor(s) 2515A-2515N use the primitive and vertex data generated by the vertex processor 2505 to produce a framebuffer that is displayed on a display device. In one embodiment, the fragment processor(s) 2515A-2515N are optimized to execute fragment shader programs as provided for in the OpenGL API, which may be used to perform similar operations as a pixel shader program as provided for in the Direct 3D API.

Graphics processor 2510 additionally includes one or more memory management units (MMUs) 2520A-2520B, cache(s) 2525A-2525B, and circuit interconnect(s) 2530A-2530B. The one or more MMU(s) 2520A-2520B provide for virtual to physical address mapping for the graphics processor 2510, including for the vertex processor 2505 and/or fragment processor(s) 2515A-2515N, which may reference vertex or image/texture data stored in memory, in addition to vertex or image/texture data stored in the one or more cache(s) 2525A-2525B. In one embodiment the one or more MMU(s) 2520A-2520B may be synchronized with other MMUs within the system, including one or more MMUs associated with the one or more application processor(s) 2405, image processor 2415, and/or video processor 2420 of FIG. 24, such that each processor 2405-2420 can participate in a shared or unified virtual memory system. The one or more circuit interconnect(s) 2530A-2530B enable graphics processor 2510 to interface with other IP cores within the SoC, either via an internal bus of the SoC or via a direct connection, according to embodiments.

As shown FIG. 25B, graphics processor 2540 includes the one or more MMU(s) 2520A-2520B, cache(s) 2525A-2525B, and circuit interconnect(s) 2530A-2530B of the graphics processor 2510 of FIG. 25A. Graphics processor 2540 includes one or more shader core(s) 2555A-2555N (e.g., 2555A, 2555B, 2555C, 2555D, 2555E, 2555F, through 2555N−1, and 2555N), which provides for a unified shader core architecture in which a single core or type or core can execute all types of programmable shader code, including shader program code to implement vertex shaders, fragment shaders, and/or compute shaders. The unified shader core architecture is also configurable to execute direct compiled high-level GPGPU programs (e.g., CUDA). The exact number of shader cores present can vary among embodiments and implementations. Additionally, graphics processor 2540 includes an inter-core task manager 2545, which acts as a thread dispatcher to dispatch execution threads to one or more shader cores 2555A-2555N and a tiling unit 2558 to accelerate tiling operations for tile-based rendering, in which rendering operations for a scene are subdivided in image space, for example to exploit local spatial coherence within a scene or to optimize use of internal caches.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow. Although not depicted, any system can include and use a power supply such as but not limited to a battery, AC-DC converter at least to receive alternating current and supply direct current, renewable energy source (e.g., solar power or motion based power), or the like.

One or more aspects of at least one example may be implemented by representative instructions stored on at least one machine-readable medium which represents various logic within a processor, processor circuit, ASIC, or FPGA which when read by a machine, computing device or system causes the machine, computing device or system to fabricate logic to perform the techniques described herein. Such representations may be stored on a tangible, machine readable medium and supplied to various customers or manufacturing facilities to load into the fabrication machines that actually make the processor, processor circuit, ASIC, or FPGA.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The following examples pertain to additional examples of technologies disclosed herein.

Example 1. An example apparatus may include circuitry at a first device coupled with a host compute device. The circuitry may determine whether a memory request received via a first link coupled with the host compute device includes a memory address to access a memory at the first device or includes a memory address to access a memory at a second device coupled with the first device via a second link included in a multi die fabric. The circuitry may also cause a memory access to the memory address of the memory at the first device or the second device based on the determination. The circuitry may also send a response to the host compute device via the first link to indicate a status of the memory access to the memory address.

Example 2. The apparatus of example 1 may also include the circuitry to determine whether the memory request includes a memory address to access the memory at the first device or includes a memory address to access the memory at the second device based on a forwarding table maintained at the first device. For this example, the forwarding table may include entries that indicate whether the memory address included in the memory request is to the memory at the first device or is to the memory at the second device.

Example 3. The apparatus of example 1 may also include the circuitry to determine the memory request includes a memory address to access the memory at the second device. The circuitry may also forward the memory request to the second device via a second link coupled with the second device. The circuitry may also receive a response, via the second link, to the memory request from the second device. The circuitry may also include the response from the second device in the response sent to the host compute device in order to indicate a status of the access to the memory address of the memory at the second device.

Example 4. The apparatus of example 3, the memory address of the memory at the second device may include a first portion of a range of memory addresses of the memory at the second device. For this example, a second portion of the range of memory addresses may be included in a second memory address of the memory at the second device. The second device may receive a second memory request from the host compute device via a second link coupled between the second device and the host compute device The second memory request may include a request to access the second memory address.

Example 5. The apparatus of example 1, wherein the first link comprises a CXL link and the second link included in the multi die fabric is a high speed internal-connect link having a data bandwidth of at least 5 times a data bandwidth of the CXL link.

Example 6. The apparatus of example 5, the memory at the first device may be a first HDM and the memory at the second device may be a second HDM.

Example 7. The apparatus of example 1 may also include compute circuitry that includes a graphics processing unit.

Example 8. An example method may include determining, by circuitry of a first device, whether a memory request received via a first link coupled with a host compute device includes a memory address for accessing a memory at the first device or includes a memory address for accessing a memory at a second device coupled with the first device via a second link included in a multi die fabric. The method may also include causing a memory access to the memory address of the memory at the first device or the second device based on the determination. The method may also include sending a response to the host compute device via the first link to indicate a status of the memory access to the memory address.

Example 9. The method of example 8, determining whether the memory request includes a memory address to access the memory at the first device or includes a memory address to access the memory at the second device further may include determining based on a forwarding table maintained at the first device, the forwarding table to include entries that indicate whether the memory address included in the memory request is to the memory at the first device or is to the memory at the second device.

Example 10. The method of example 8 may also include determining the memory request includes a memory address to access the memory at the second device. The method may also include forwarding the memory request to the second device via a second link coupled with the second device. The method may also include receiving a response, via the second link, to the memory request from the second device and including the response from the second device in the response sent to the host compute device in order to indicate a status of the access to the memory address of the memory at the second device.

Example 11. The method of example 10, the memory address of the memory at the second device may be a first portion of a range of memory addresses of the memory at the second device. For this example, a second portion of the range of memory addresses may be included in a second memory address of the memory at the second device. The second device may receive a second memory request from the host compute device via a second link coupled between the second device and the host compute device. The second memory request may include a request to access the second memory address.

Example 12. The method of example 8, the first link may be a CXL link and the second link included in the multi die fabric may be a high speed internal-connect link having a data bandwidth of at least 5 times a data bandwidth of the CXL link.

Example 13. The method of example 12, the memory at the first device may be a first HDM and the memory at the second device may be a second HDM.

Example 14. An example at least one machine readable medium may include a plurality of instructions that in response to being executed by a system may cause the system to carry out a method according to any one of examples 8 to 13.

Example 15. An example apparatus may include means for performing the methods of any one of examples 8 to 13.

Example 16. An example at least one non-transitory computer-readable storage medium, may include a plurality of instructions, that when executed, may cause circuitry at a device coupled with a host device to determine whether a memory request received via a first link coupled with the host compute device includes a memory address to access a memory at the device or includes a memory address to access a memory at a second device coupled with the device via a second link included in a multi die fabric. The instructions may also cause the circuitry to cause a memory access to the memory address of the memory at the device or the second device based on the determination. The instructions may also cause the circuitry to send a response to the host compute device via the first link to indicate a status of the memory access to the memory address.

Example 17. The at least one non-transitory computer-readable storage medium of example 16, the instructions may further cause the circuitry to determine whether the memory request includes a memory address to access the memory at the device or includes a memory address to access the memory at the second device based on a forwarding table maintained at the device. For this example, the forwarding table may include entries that indicate whether the memory address included in the memory request is to the memory at the device or is to the memory at the second device.

Example 18. The at least one non-transitory computer-readable storage medium of example 16, the instructions may further cause the circuitry to determine the memory request includes a memory address to access the memory at the second device. The instructions may also cause the circuitry to forward the memory request to the second device via a second link coupled with the second device. The instructions may also cause the circuitry to receive a response, via the second link, to the memory request from the second device. The instructions may also cause the circuitry to include the response from the second device in the response sent to the host compute device in order to indicate a status of the access to the memory address of the memory at the second device.

Example 19. The at least one non-transitory computer-readable storage medium of example 18, the memory address of the memory at the second device may be a first portion of a range of memory addresses of the memory at the second device. For this example, a second portion of the range of memory addresses may be included in a second memory address of the memory at the second device, the second device to receive a second memory request from the host compute device via a second link coupled between the second device and the host compute device, the second memory request to include a request to access the second memory address.

Example 20. The at least one non-transitory computer-readable storage medium of example 16, the first link may be a CXL link and the second link included in the multi die fabric may be a high speed internal-connect link having a data bandwidth of at least 5 times a data bandwidth of the CXL link.

Example 21. The at least one non-transitory computer-readable storage medium of example 20, the memory at the device may be a first HDM and the memory at the second device may be a second HDM.

Example 22. The at least one non-transitory computer-readable storage medium of example 16, the device may include a graphics processing unit to function as compute circuitry for the device.

Example 23. An example at least one non-transitory computer-readable storage medium, may include a plurality of instructions, that when executed by a system at a host compute device may cause the system to initialize a plurality of devices coupled with the host compute device via separate host links. The instructions may also cause the system to access, via the host links, registers at each device to gather information on a device's capability to route a memory request received via a host link to other devices of the plurality of devices. The memory request may be routed via one of multiple HSILs that couple the plurality of devices together. The instructions may also cause the system to build a system memory address mapping based on the gathered information. The system memory address mapping may be for use by the host compute device to access a memory address for memory at a respective device from among the plurality of devices. The instructions may also cause the system to cause separate forwarding tables to be maintained at each device from among the plurality of devices, the separate forwarding tables to indicate a device's capability to route a memory request to access a memory address of a memory at another device from among the plurality of devices. The memory request may be received via a host link coupled with the host compute device and forwarded to the other device via an HSIL based on the device's forwarding table.

Example 24. The at least one non-transitory computer-readable storage medium of example 23, the separate forwarding tables to be maintained at each device may include the separate forwarding tables maintained in respective registers at each device.

Example 25. The at least one non-transitory computer-readable storage medium of example 23, the host links may be CXL links and the HSILs that couple the plurality of devices together may be included in a multi die fabric. Each HSIL may have a data bandwidth of at least 5 times a data bandwidth of a single CXL link.

Example 26. The at least one non-transitory computer-readable storage medium of example 25, memory at each respective device may be HDM.

Example 27. The at least one non-transitory computer-readable storage medium of example 26, the system may be a basic input/output system (BIOS) for the host compute device. For these examples, the instructions may further cause the BIOS to fill, based on the information gathered from device registers, a CBHS for use by an OS of the host compute device to build a mapping table for each HDM at each respective device of the plurality of devices. The mapping table may facilitate access by the OS to a memory address of an HDM via multiple CXL links. One of the multiple CXL links may be coupled to the device having the HDM and the remaining CXL links of the multiple CXL links may be coupled to other devices from among the plurality of devices.

Example 28. The at least one non-transitory computer-readable storage medium of example 23, the plurality of devices may each include a graphics processing unit to function as compute circuitry.

Example 29. An example at least one non-transitory computer-readable storage medium may include a plurality of instructions, that when executed by a system at a host compute device may cause the system to receive a request to access a memory address of a memory at a first device from among a plurality of devices coupled with the host compute device via separate host links. The instructions may also cause the system to obtain memory address mapping information to determine how to split the memory address into multiple portions that include at least a first portion and a second portion. The instructions may also cause the system to send the first portion of the memory address to the first device in a first memory request message via a first host link to access the first portion of the memory address of the memory at the first device. The instructions may also cause the system to send, in a second memory request via a second host link, the second portion of the memory address to a second device from among the plurality of devices. The second memory request may be forwarded to the first device via a first HSIL to access the second portion of the memory address of the memory at the first device.

Example 30. The at least one non-transitory computer-readable storage medium of example 29, may further include the instructions to cause the system to split the memory address into multiple portions that include a third portion. For these examples, system may send, in a third memory request via a third host link, the third portion of the memory address to a third device from among the plurality of devices. The third memory request may be forwarded to the first device via a second HSIL to access the third portion of the memory address of the memory at the first device.

Example 31. The at least one non-transitory computer-readable storage medium of example 30, the instructions may also cause the system to receive, via the first host link, a first response from the first device for the first memory request, the first response to indicate a status of the access to the first portion of the memory address of the memory at the first device. The instructions may also cause the system to receive, via the second host link, a second response from the second device for the second memory request, the second response to indicate a status of the access to the second portion of the memory address of the memory at the first device. The instructions may also cause the system to receive, via the third host link, a third response from the third device for the third memory request, the third response to indicate a status of the access to the third portion of the memory address of the memory at the first device.

Example 32. The at least one non-transitory computer-readable storage medium of example 29, the separate host links may be CXL links and the first HSIL may be included in a multi die fabric that includes multiple HSILs that couple the plurality of devices to each other. Each HSIL of the multiple HSILs may have a data bandwidth of at least 5 times a data bandwidth of a single CXL link.

Example 33. The at least one non-transitory computer-readable storage medium of example 32, the memory at the first device may be HDM.

Example 34. The at least one non-transitory computer-readable storage medium of example 29, the plurality of devices may each include a graphics processing unit to function as compute circuitry.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1.-27. (canceled)

28. An apparatus comprising:
circuitry at a first device coupled with a host compute device, the circuitry to:
determine whether a memory request received via a first link coupled with the host compute device includes a memory address to access a memory at the first device or includes a memory address to access a memory at a second device coupled with the first device via a second link included in a multi die fabric;
cause a memory access to the memory address of the memory at the first device or the second device based on the determination; and
send a response to the host compute device via the first link to indicate a status of the memory access to the memory address.

29. The apparatus of claim 28, further comprising the circuitry to determine whether the memory request includes a memory address to access the memory at the first device or includes a memory address to access the memory at the second device based on a forwarding table maintained at the first device, the forwarding table to include entries that indicate whether the memory address included in the memory request is to the memory at the first device or is to the memory at the second device.

30. The apparatus of claim 28, further comprising the circuitry to:
determine the memory request includes a memory address to access the memory at the second device;
forward the memory request to the second device via a second link coupled with the second device;
receive a response, via the second link, to the memory request from the second device; and
include the response from the second device in the response sent to the host compute device in order to indicate a status of the access to the memory address of the memory at the second device.

31. The apparatus of claim 30, the memory address of the memory at the second device comprises a first portion of a range of memory addresses of the memory at the second device, wherein a second portion of the range of memory addresses is included in a second memory address of the memory at the second device, the second device to receive a second memory request from the host compute device via a second link coupled between the second device and the host compute device, the second memory request to include a request to access the second memory address.

32. The apparatus of claim 28, wherein the first link comprises a Compute Express Link (CXL) link and the second link included in the multi die fabric is a high speed internal-connect link having a data bandwidth of at least 5 times a data bandwidth of the CXL link.

33. The apparatus of claim 32, wherein the memory at the first device comprises a first host-managed device memory (HDM) and the memory at the second device comprises a second HDM.

34. The apparatus of claim 28, further comprising:
compute circuitry that includes a graphics processing unit.

35. A method comprising:
determining, by circuitry of a first device, whether a memory request received via a first link coupled with a host compute device includes a memory address for accessing a memory at the first device or includes a memory address for accessing a memory at a second device coupled with the first device via a second link included in a multi die fabric;
causing a memory access to the memory address of the memory at the first device or the second device based on the determination; and
sending a response to the host compute device via the first link to indicate a status of the memory access to the memory address.

36. The method of claim 35, wherein determining whether the memory request includes a memory address to access the memory at the first device or includes a memory address to access the memory at the second device further comprises determining based on a forwarding table maintained at the first device, the forwarding table to include entries that indicate whether the memory address included in the memory request is to the memory at the first device or is to the memory at the second device.

37. The method of claim 35, further comprising:
determining the memory request includes a memory address to access the memory at the second device;
forwarding the memory request to the second device via a second link coupled with the second device;
receiving a response, via the second link, to the memory request from the second device; and
including the response from the second device in the response sent to the host compute device in order to indicate a status of the access to the memory address of the memory at the second device.

38. The method of claim 37, the memory address of the memory at the second device comprises a first portion of a range of memory addresses of the memory at the second device, wherein a second portion of the range of memory addresses is included in a second memory address of the memory at the second device, the second device to receive a second memory request from the host compute device via a second link coupled between the second device and the host compute device, the second memory request to include a request to access the second memory address.

39. The method of claim 35, wherein the first link comprises a Compute Express Link (CXL) link and the second link included in the multi die fabric is a high speed internal-connect link having a data bandwidth of at least 5 times a data bandwidth of the CXL link, and wherein the memory at the first device comprises a first host-managed device memory (HDM) and the memory at the second device comprises a second HDM.

40. At least one non-transitory computer-readable storage medium, comprising a plurality of instructions, that when executed by a system at a host compute device cause the system to:
initialize a plurality of devices coupled with the host compute device via separate host links;
access, via the host links, registers at each device to gather information on a device's capability to route a memory request received via a host link to other devices of the plurality of devices, the memory request to be routed via one of multiple high speed internal-connect links (HSILs) that couple the plurality of devices together;
build a system memory address mapping based on the gathered information, the system memory address mapping for use by the host compute device to access a memory address for memory at a respective device from among the plurality of devices; and
cause separate forwarding tables to be maintained at each device from among the plurality of devices, the separate forwarding tables to indicate a device's capability to route a memory request to access a memory address of a memory at another device from among the plurality of devices, the memory request received via a host link coupled with the host compute device and forwarded to the other device via an HSIL based on the device's forwarding table.

41. The at least one non-transitory computer-readable storage medium of claim 40, wherein the separate forwarding tables to be maintained at each device comprises the separate forwarding tables maintained in respective registers at each device.

42. The at least one non-transitory computer-readable storage medium of claim 41, wherein the host links comprise Compute Express Link (CXL) links and the HSILs that couple the plurality of devices together are included in a multi die fabric, each HSIL having a data bandwidth of at least 5 times a data bandwidth of a single CXL link, and, wherein memory at each respective device comprises host-managed device memory (HDM).

43. The at least one non-transitory computer-readable storage medium of claim 42, wherein the system comprises a basic input/output system (BIOS) for the host compute device, the instructions to further cause the BIOS to:
fill, based on the information gathered from device registers, a CXL binding virtual HDM (vHDM) structure (CBHS) for use by an operating system (OS) of the host compute device to build a mapping table for each HDM at each respective device of the plurality of devices, the mapping table to facilitate access by the OS to a memory address of an HDM via multiple CXL links, wherein one of the multiple CXL links is coupled to the device having the HDM and the remaining CXL links of the multiple CXL links are coupled to other devices from among the plurality of devices.

44. At least one non-transitory computer-readable storage medium, comprising a plurality of instructions, that when executed by a system at a host compute device cause the system to:
receive a request to access a memory address of a memory at a first device from among a plurality of devices coupled with the host compute device via separate host links;
obtain memory address mapping information to determine how to split the memory address into multiple portions that include at least a first portion and a second portion;
send the first portion of the memory address to the first device in a first memory request message via a first host link to access the first portion of the memory address of the memory at the first device; and
send, in a second memory request via a second host link, the second portion of the memory address to a second device from among the plurality of devices, the second memory request to be forwarded to the first device via a first high speed internal-connect link (HSIL) to access the second portion of the memory address of the memory at the first device.

45. The at least one non-transitory computer-readable storage medium of claim 44, further comprising the instructions to cause the system to split the memory address into multiple portions that include a third portion, wherein the system is to:
send, in a third memory request via a third host link, the third portion of the memory address to a third device from among the plurality of devices, the third memory request to be forwarded to the first device via a second HSIL to access the third portion of the memory address of the memory at the first device.

46. The at least one non-transitory computer-readable storage medium of claim 45, further comprising the instructions to cause the system to:
receive, via the first host link, a first response from the first device for the first memory request, the first response to indicate a status of the access to the first portion of the memory address of the memory at the first device;
receive, via the second host link, a second response from the second device for the second memory request, the second response to indicate a status of the access to the second portion of the memory address of the memory at the first device; and
receive, via the third host link, a third response from the third device for the third memory request, the third response to indicate a status of the access to the third portion of the memory address of the memory at the first device.

47. The at least one non-transitory computer-readable storage medium of claim 44, wherein the separate host links comprise Compute Express Link (CXL) links and the first HSIL is included in a multi die fabric that includes multiple HSILs that couple the plurality of devices to each other, each HSIL of the multiple HSILs having a data bandwidth of at least 5 times a data bandwidth of a single CXL link, and wherein the memory at the first device comprises host-managed device memory (HDM).
